(19) United States
(12) Patent Application Publication
(10) Pub. No.: US 2026/0085210 A1
(43) Pub. Date: Mar. 26, 2026

(54) MULTILAYER COATING SYSTEMS OBTAINED FROM BLOCK COPOLYMER CONTAINING BASECOAT COMPOSITIONS

(71) Applicants: BASF COATINGS GMBH, Muenster (DE); CYPRIS MATERIALS, Berkeley, CA (US)

(72) Inventors: Zenon Paul CZORNIJ, Brighton, MI (US); Daniel Patrick FERRIS, Southfield, MI (US); Daniel W. JOHNSON, Southfield, MI (US); Qingling ZHANG, Southfield, MI (US); Donald H. CAMPBELL, Hartland, MI (US); Ryan PEARSON, Berkeley, CA (US); Matthew RYAN, Berkeley, CA (US); Luke WHITSON, Berkeley, CA (US)

(21) Appl. No.: 19/113,544

(22) PCT Filed: Oct. 5, 2023
(86) PCT No.: PCT/EP2023/077629

§ 371 Date: Mar. 20, 2025

(30) Foreign Application Priority Data
Oct. 7, 2022 (EP) 22200386.5

(51) Int. Cl. C09D 187/00; C09D 5/36; C09D 7/40; C09D 7/62

(52) U.S. Cl. CPC C09D 187/005; C09D 5/36; C09D 7/62; C09D 7/69; C09D 7/70

(57) ABSTRACT

Disclosed herein are a multilayer coating system present on a substrate and including at least three coating layers L1, L2 and L3 being different from one another, namely first coating layer L1 including at least one kind of platelet-shaped pigment applied over at least a portion of the substrate, a second coating layer L2 applied over the first coating layer L1, and a third coating layer L3 applied over the second coating layer L2, wherein the second coating layer L2 is formed from a coating composition including at least one block copolymer containing a backbone and at least two blocks B1 and B2 and side chains S1 and S2 including different polymeric moieties M1 and M2, a method of preparing the multilayer coating system, a coated substrate obtained therefrom, and a method of using a coating composition including the block copolymer for improving, in particular for increasing, the chromaticity of the multilayer coating system.

The present invention relates to a multilayer coating system present on a substrate and comprising at least three coating layers L1, L2 and L3 being different from one another, namely a first coating layer L1 comprising platelet-shaped pigments, which is applied over at least a portion of the substrate, a second coating layer L2 applied over the first coating layer L1, and a third coating layer L3 applied over the second coating layer L2, wherein the second coating layer L2 is formed from a coating composition comprising at least one block copolymer containing a backbone and at least two blocks B1 and B2 and side chains S1 and S2 comprising different polymeric moieties M1 and M2, a method of preparing said multilayer coating system, a coated substrate obtainable therefrom

### BACKGROUND OF THE INVENTION

In typical automotive coating processes, usually multiple layers are applied to the surface of a suitable substrate such as a metallic substrate in form of a multilayer coating system: for example, an electrodeposition coat (e-coat), optionally a primer, one or two basecoats, and a topcoat, in particular a clearcoat, as outermost layer, are applied in this sequence. At least the e-coat layer is generally applied to the substrate surface and then cured before any of the further coatings are applied on top. Subsequent to applying and curing at least the electrodeposition coating film, and also subsequent to optionally applying a primer, at least one (first) basecoat formulation, which is usually pigmented, is then applied. Often, a second basecoat is applied on top of the first basecoat film as a further intermediate coating film. Then, a topcoat such as a clearcoat is usually applied, wherein at least the basecoats and the topcoat are nowadays typically applied making use of a wet-on-wet-application. Afterwards the coated substrate is passed through an oven at temperatures to cure at least the basecoat(s) and the topcoat such as the clearcoat simultaneously. In some cases, also the primer coat—if present—is cured at this stage together with the basecoat(s) and topcoat, in particular clearcoat.

There are quite a number of requirements necessary, which have to be fulfilled and/or met by the multilayer coatings used in the automotive industry due to regulations, but also due to quality standards set by the automotive industry as such. Thus, the multilayer coatings have to exhibit or display a number of desired characteristics to at least a sufficient extent in order to meet these requirements. For example, an avoidance of optical defects is desired. In addition, and in particular, it is desired that excellent coloristic properties of the multilayer coatings are achieved.

Multilayer coatings composed of at least two coating layers are e.g., disclosed in WO 2020/160299 A1. The first layer is a photonic crystal film comprising a pigment and a block copolymer. The second layer present on the first layer is used as topcoat, and is an optical adhesive or an UV curable resin. The block copolymer is necessarily present in the first layer together with at least one pigment. WO 2020/160299 A1 aims at providing multilayer coatings with good transparency in the visible spectrum. Coating compositions used for preparing pigmented photonic crystal films as such are further disclosed in WO 2020/180427 A1, but no multilayer coatings are disclosed therein, let alone multilayer coatings prepared via a wet-on-wet technique.

As the multilayer coatings known in the state of the art not always exhibit sufficiently good coloristic properties, e.g., with respect to lightness, but particular with respect to chromaticity, there is a need to provide cured coatings and coating systems, which exhibit improved coloristic properties and color values compared to the coatings and coating systems known in the prior art, in particular with respect to their chromaticity and achievement of excellent chroma values. However, in addition thereto, particularly for effect pigment containing multilayer coatings making use of platelet-shaped effect pigments in a basecoat layer, there is a need to improve color transition properties. Furthermore, these cured coatings and coating systems ought to be prepared in an economically advantageous manner, in particular with respect to as short as possible process times including as short as possible curing times, especially when these coatings and coating systems are used in automotive OEM production.

### Problem

It has been therefore an object underlying the present invention to provide multilayer coating systems, which exhibit improved coloristic properties and color values compared to the coatings and coating systems known in the prior art, in particular with respect to their chromaticity and achievement of excellent chroma values, and which, at the same time, exhibit a unique color transition and can be prepared in an economically advantageous manner, in particular with respect to as short as possible process times including as short as possible curing times, especially when these multilayer coating systems are used in automotive OEM production.

### Solution

This object has been solved by the subject-matter of the claims of the present application as well as by the preferred embodiments thereof disclosed in this specification, i.e., by the subject matter described herein.

A first subject-matter of the present invention is a multilayer coating system being present on an optionally pre-coated substrate and comprising at least three coating layers L1, L2 and L3 being different from one another, namely
a first coating layer L1 comprising at least one kind of a platelet-shaped pigment applied over at least a portion of an optionally pre-coated substrate,
a second coating layer L2 applied over the first coating layer L1, and
a third coating layer L3 applied over the second coating layer L2,
characterized in that
the second coating layer L2 is formed from a coating composition comprising at least one block copolymer containing a backbone and at least two blocks B1 and B2 being different from one another,
   wherein block B1 comprises at least one kind of side chains S1 attached to the backbone and block B2 comprises at least one kind of side chains S2 attached to the backbone, which are different from side chains S1, wherein each of side chains S1 comprises at least one polymeric moiety M1 being selected from the group consisting of polyester, polyether and poly(meth)acrylate moieties, and each of side chains S2 comprises at least one polymeric moiety M2 being different from polymeric moiety M1 and being selected from the group consisting of polyester, poly(meth)acrylate, polyether, polysiloxane and polystyrene moieties.

A further subject-matter of the present invention is a method for preparing the inventive multilayer coating system comprising at least steps (1), (2), (3) and (4), namely
(1) applying a first basecoat composition comprising at least one kind of a platelet-shaped pigment to at least a portion of an optionally pre-coated substrate and forming a first coating film on at least a portion of the optionally pre-coated substrate,
(2) applying a second basecoat composition comprising the at least one block copolymer as defined for the multilayer coating system and being different from the first basecoat composition applied in step (1) to the first coating film present on the substrate obtained after step (1) and forming a second coating film, which preferably is adjacent to the first coating film,
(3) applying a coating composition different from the compositions applied in steps (1) and (2) to the second coating film present on the substrate obtained after step (2) and forming a third coating film, which is preferably adjacent to the second coating film, wherein said coating composition is preferably a clearcoat composition, and
(4) jointly curing at least the second and third coating films applied in steps (2) and (3) and optionally also the first coating film applied in step (1) in case said first coating film was not cured prior to performing of step (2) to obtain the multilayer coating system comprising at least the first, the second and the third coating layers L1, L2 and L3.

A further subject-matter of the present invention is a coated substrate obtainable by the inventive method.

The inventively used block copolymer is also referred to as a brush block copolymer (BBCP) hereinafter.

Further, it has been in particular surprisingly found that the multilayer coating systems can be produced in an economically advantageous manner, in particular with respect to short process times and short curing times, especially when these coatings and coating systems are used in automotive OEM production.

It has been found particularly surprisingly that the aforementioned advantageous effects are a result of the incorporation of a block copolymer BBCP into a coating composition and of using said coating composition as a midcoat composition (second basecoat composition) when preparing the inventive multilayer coating system. It has been further surprisingly found that these effects can be in particular observed in an advantageous manner, when a specific wet-on-wet-application is used for preparing the multilayer coating systems, wherein the applied coating composition comprising the at least one block copolymer BBCP, which is used for preparing the second coating layer L2, and the applied coating composition used for preparing the third coating layer L3 are jointly cured, i.e. simultaneously cured, to obtain the second and third coating layers L2 and L3 of the multilayer coating system.

### DETAILED DESCRIPTION OF THE INVENTION

The term “comprising” in the sense of the present invention, in connection for example with the coating compositions used in the inventive method or for preparing the inventive multilayer coating system, preferably has the meaning of “consisting of”. With regard, e.g., to the second basecoat composition, it is possible—in addition to all mandatory constituents present therein—for one or more of the further constituents identified hereinafter and included optionally therein to be also included therein. All constituents may in each case be present in their preferred embodiments as identified below.

The proportions and amounts in wt.-% (% by weight) of any of the constituents given hereinafter, which are present in each of the coating compositions add up to 100 wt.-%, based in each case on the total weight of the respective composition.

Each of the coating compositions used in steps (1), (2), and (3) of the inventive method and/or used for preparing coating layers L1, L2 and L3 may contain—besides the constituents outlined in more detail hereinafter—one or more commonly used additives depending on the desired application. For example, each of the coating compositions may comprise independently of one another at least one additive selected from the group consisting of reactive diluents, catalysts, light stabilizers, antioxidants, deaerators, emulsifiers, slip additives, polymerization inhibitors, plasticizers, initiators for free-radical polymerizations, adhesion promoters, flow control agents, film-forming auxiliaries, sag control agents (SCAs), flame retardants, corrosion inhibitors, siccatives, thickeners, biocides and/or matting agents. They can be used in known and customary proportions. Preferably, their content, based on the total weight of each the coating composition is 0.01 to 20.0 wt.-%, more preferably 0.05 to 15.0 wt.-%, particularly preferably 0.1 to 10.0% By weight, most preferably from 0.1 to 7.5% by weight, especially from 0.1 to 5.0% by weight and most preferably from 0.1 to 2.5% by weight.

Each of the coating compositions used in the inventive method, in particular in each of steps (1) to (3), and/or for preparing the multilayer coating system can be aqueous (waterborne) or organic solvent(s) based (solvent-borne, non-aqueous).

The term “solvent-borne” or “non-aqueous” is understood preferably for the purposes of the present invention to mean that organic solvent(s), as solvent(s) and/or as diluent(s), is/are present as the main constituent of all solvents and/or diluents present in the respective coating composition such as in the second basecoat composition applied in step (2) of the inventive method if the respective coating composition is solvent-borne. Preferably, organic solvent(s) are present in an amount of at least 35 wt.-%, based on the total weight of the coating composition. A solvent-borne coating composition preferably includes an organic solvent(s) fraction of at least 40 wt.-%, more preferably of at least 45 wt.-%, very preferably of at least 50 wt.-%, based in each case on the total weight of the coating composition. All conventional organic solvents known to those skilled in the art can be used as organic solvents. The term “organic solvent” is known to those skilled in the art, in particular from Council Directive 1999/13/EC of 11 Mar. 1999. Examples of such organic solvents would include heterocyclic, aliphatic, or aromatic hydrocarbons, mono- or polyhydric alcohols, especially methanol and/or ethanol, ethers, esters, ketones, and amides, such as, for example, N-methylpyrrolidone, N-ethylpyrrolidone, dimethylformamide, toluene, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof. A solvent-borne coating composition preferably is free or essentially free of water. The term “essentially” in this context preferably means that no water is added on purpose when preparing the coating composition.

The term “waterborne” or “aqueous” is understood preferably for the purposes of the present invention to mean that water is present as the main constituent of all solvents and/or diluents present an aqueous coating composition such as the first basecoat composition applied in step (1) of the inventive method. Preferably, water is present in an amount of at least 35 wt.-%, based on the total weight of the coating composition. An aqueous coating composition preferably includes a water fraction of at least 40 wt.-%, more preferably of at least 45 wt.-%, very preferably of at least 50 wt.-%, based in each case on the total weight of the coating composition. The fraction of organic solvent(s) is preferably <20 wt.-%, more preferably in a range of from 0 to <20 wt.-%, very preferably in a range of from 0.5 to 20 wt.-% or to 17.5 wt.-% or to 15 wt.-% or to 10 wt.-%, based in each case on the total weight of the coating composition.

Polymer-specific terminology, if not defined differently in the present invention, is used in accordance with the International Union of Pure and Applied Chemistry Recommendations 2008 issued by IUPAC's Polymer Division and published in the “Compendium of Polymer Terminology and Nomenclature” (RSC Publishing, ©2009, ISBN: 978-0-85404-491-7).

Coatings-specific terminology, if not defined differently in the present invention, is used in accordance with DIN EN ISO 4618 (German version, date: March 2007).

### Inventive Multilayer Coating System

The inventive multilayer coating system is present on an optionally pre-coated substrate and comprises at least three coatings layers L1, L2 and L3 and as defined above being different from one another.

Preferably, at least the second and the third coating layers L2 and L3 are positioned adjacently to each other. More preferably, the first and the second coating layers L1 and L2 are also positioned adjacently to each other. Most preferred the first, second and the third coating layers L1, L2 and L3 are positioned adjacently to each other, and coating layers L1 and L2 are at least partially transparent for visible light.

Preferably, the multilayer coating system is obtainable by a method, according to which at least the applied coating composition comprising the at least one block copolymer BBCP, which is used for preparing the second coating layer L2, and the applied coating composition used for preparing the third coating layer L3 are jointly cured to obtain the second and third coating layers L2 and L3 of the multilayer coating system.

Curing is preferably selected from chemical curing such as chemical crosslinking, radiation curing, and/or physically drying (non-chemical curing), in each case at room temperature or at an elevated temperature, more preferably is selected from chemical curing such as chemical crosslinking, and/or physically drying (non-chemical curing), in each case at room temperature or at an elevated temperature, in each case preferably wherein the minimum curing temperature applied for curing is 80° C.

### Substrate

The inventive multilayer coating system is particularly suitable as a coating of automotive vehicle bodies or parts thereof including respective metallic substrates, but also plastic substrates such as polymeric substrates. Consequently, the preferred substrates are automotive vehicle bodies or parts thereof.

Suitability as metallic substrates used in accordance with the invention are all substrates used customarily and known to the skilled person. The substrates used in accordance with the invention are preferably metallic substrates, more preferably selected from the group consisting of steel, preferably steel selected from the group consisting of bare steel, cold rolled steel (CRS), hot rolled steel, galvanized steel such as hot dip galvanized steel (HDG), alloy galvanized steel (such as, for example, Galvalume, Galvannealed or Galfan) and aluminized steel, aluminum and magnesium, and also Zn/Mg alloys and Zn/Ni alloys. Particularly suitable substrates are parts of vehicle bodies or complete bodies of automobiles for production.

Preferably, thermoplastic and thermosetting polymers are used as plastic substrates. Suitable polymers are poly(meth)acrylates including polymethyl(meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred.

The substrate used in accordance with the invention is preferably a metallic substrate pretreated with at least one conversion coating composition such as a metal phosphate containing composition like zinc phosphate containing composition and/or pretreated with an oxalate. A pretreatment of this kind by means of phosphating, which takes place normally after the substrate has been cleaned and before the substrate is electrodeposition-coated, is in particular a pretreatment step that is customary in the automobile industry.

As outlined above the substrate used may be a pre-coated substrate, i.e. a substrate bearing at least one cured coating film. The substrate can be pre-coated with a cured electrodeposition coating layer. The substrate can, e.g., be provided additionally or alternatively with at least one cured or uncured primer coating film as at least one additional pre-coat. The term “primer” is known to a person skilled in the art. A primer typically is applied after the substrate has been provided with a cured electrodeposition coating layer. In case a cured primer coating film is present, the cured electrodeposition coating film is present underneath and preferably adjacent to the cured primer coating film. Curing of this primer may preferably take place at temperatures in the range of from 40 to 140° C. and may in particular include a “low baking” step at a temperature in the range of from 80 to 100° C. As outlined above a substrate provided with an uncured primer coating film may also be used, in particular a substrate such as a metallic substrate bearing a cured electrodeposition coating film, onto which said uncured primer coating film is present. Thus, a primer composition can be applied to an optionally pre-coated substrate and forming a primer coating film on the optionally pre-coated substrate. Then, an optional curing step of this primer coating film is possible. Then, a coating composition used for forming the first coating layer L1 can be subsequently applied before or after curing of said primer coating film has taken place, optionally and preferably after a flash-off period such as a flash-off period of 1 to 20 minutes, preferably at a temperature not exceeding 40° C., such as at a temperature in the range of from 18 to 30° C.

### Coating Layer L1 and First Basecoat Composition Used for Forming Said Layer

The first coating layer L1, which comprises at least one kind of platelet-shaped pigment, is applied over at least a portion of an optionally pre-coated substrate. Thus, the first coating layer L1 is present on at least part of a surface of an optionally pre-coated substrate.

Preferably, the first coating layer L1 is capable of at least partially reflecting, but also and even more preferably additionally at least partially absorbing those wavelengths that are not reflected by the second layer L2.

The first coating layer L1 is formed from a pigmented coating composition comprising at least one kind of a platelet-shaped pigment and preferably also at least one kind of a non-platelet-shaped, preferably absorbing pigment. Such coating composition is also referred to herein as first basecoat composition. This composition is the composition used in step (1) of the inventive method.

The first basecoat composition is preferably an aqueous, i.e., waterborne, coating composition, or is a solvent-borne basecoat composition. In particular, it is a solvent-borne basecoat composition. The first basecoat composition can be 1K- (one-component) or 2K- (two components) composition. Preferably, it is a 1 K-composition.

The term “basecoat” is known in the art and, for example, defined in Römpp Lexikon, paints and printing inks, Georg Thieme Verlag, 1998, 10th edition, page 57. A basecoat is therefore in particular used in automotive painting and general industrial paint coloring in order to give a coloring and/or an optical effect by using the basecoat as an intermediate coating composition.

### Pigments

The first basecoat composition is pigmented. The term “pigment” is known to the skilled person, from DIN 55943 (date: October 2001), for example. A “pigment” in the sense of the present invention refers preferably to a colorant and/or an optical effect providing constituent in particulate form such as in powder or platelet-shaped form which is substantially, preferably entirely, insoluble in the medium surrounding them, such as in one of the inventively used coating compositions, for example. Pigments differ from “fillers” preferably in their refractive index, which for pigments is 1.7. The term “filler” is known to the skilled person, from DIN 55943 (date: October 2001), for example. Pigments can be inorganic or organic.

### Platelet-Shaped Pigments

The first basecoat composition contains at least one kind of a platelet-shaped pigment. The term “platelet-shaped pigment” as used in the field of coatings refers to platelet-shaped metal effect pigments as well as to so-called platelet-shaped special effect pigments. These special effect pigments are typically grouped into pearlescent and interference pigments.

Platelet-shaped pigments, as used herein, preferably possess a numerical average platelet thicknesses h₅₀ in the range from 30 nm to 1 μm, and preferably a median platelet diameter D₅₀, ranging from 5 μm to 40 μm, and thus the aspect ratios D₅₀/h₅₀ preferably range from about 5:1 to about 1300:1. D₅₀ being the volume-based median particle size as measured by use of a laser diffraction particle analyzer, e.g., a Malvern Mastersizer 3000 (available from Malvern Panalytical, Ltd., UK) and h₅₀ being the average particle thickness. The average thickness h₅₀ constitutes the value at which 50% of the platelet-shaped pigments in a cumulative frequency distribution, also referred to as a cumulative passage curve, are of the specified thickness or less, wherein at least 100 pigments, for example 100 pigments, are measured. The value for h₅₀ can be determined by preparing a cured coating containing the pigments. It is important to ensure the most favorable possible orientation of the flakes in the application medium. After this, the cured coating is partially abraded, and its cross-section is observed by electron microscopy (SEM or TEM, both being equivalent for the purpose of the present invention). Only particles showing a favorable orientation are counted.

Amongst the platelet-shaped metal effect pigments, platelets from single metals or their alloys can be employed. Such metal effect pigments are typically aluminum platelets, zinc-copper platelets, copper platelets, nickel platelets or steel platelets, most preferred are aluminum and copper platelets, aluminum platelets being particularly preferred. Typical platelet-shapes are so-called silver dollar and cornflake shapes, particularly for aluminum pigments. Very thin metallic effect pigments are, e.g., PVD pigments (i.e., physical vapor deposition pigments). Platelet-shaped metal effect pigments can be surface-modified, i.e., modified or coated with inorganic or organic compounds. Such modification can be an oxidation of the pigment surface, or the application of a metal oxide coating, or an organic coating with, e.g., with organo silanes or organic colorants.

Amongst the platelet-shaped special effect pigments, particularly coated platelets selected from mica, silica, alumina, glass and borosilicate can be employed. The coatings of the afore-mentioned types of platelets can be non-absorbing coatings, such as coatings comprising or consisting of TiO₂ (rutile), TiO₂ (anatase), ZrO₂, SnO₂ and SiO₂, or selectively absorbing coatings such as a FeOOH, Fe₂O₃, Cr₂O₃, TiO₂₋ₓ, TiOₓN_{y}, KFe[Fe(CN)₆] or colorant coatings.

Further platelet-shaped special effect pigments are, e.g., platelet-shaped substrate-free pearlescent pigments, such as natural pearl essence, basic lead carbonate, bismuth oxychloride, micaceous iron oxide and titanium dioxide flakes.

An aqueous or non-aqueous pigment paste comprising the at least one platelet-shaped pigment is preferably used for preparing the first basecoat composition, depending on whether the first basecoat composition is solvent-borne or aqueous.

The amount of platelet-shaped effect pigments for inventive use in the coating compositions may vary widely and is guided on the one hand by the opacity of the effect pigment and by the intensity of the optical effect it is desired to obtain. Preferably, the first basecoat composition of the invention comprises 0.5 to 12.5 wt.-%, more preferably 1.0 to 10.0 wt.-% and most preferably 2.0 to 6.0 wt.-%, based on the total weight of the coating composition, of one or more kinds of platelet-shaped pigments.

### Non-Platelet-Shaped Pigments

Preferably, the first basecoat composition further comprises at least one visual light (wavelength from 380 to 750 nm) absorbing non-platelet shaped pigment, more preferably at least one black and/or coloring pigment, most preferably at least one black pigment, in particular at least one inorganic black pigment and/or at least one organic black pigment.

If at least one organic black pigment is present in the first basecoat composition, it is preferably at least one perylene black pigment, such as Pigment Black 31 or Pigment Black 32. The most preferred black organic pigments perylene black P.B. 32. If at least one inorganic black pigment is present in the first basecoat composition, it is preferably at least one carbon black pigment.

An aqueous or non-aqueous pigment paste comprising the at least one pigment is preferably used for preparing the first basecoat composition, depending on whether the first basecoat composition is solvent-borne or aqueous.

Preferably, then at least one non-platelet-shaped pigment, which is preferably present in the first basecoat composition is contained therein in an amount in the range of from 0.1 to 25.0 wt.-%, more preferably of from 0.3 to 10.0 wt.-%, even more preferably of from 0.5 to 7.5 wt.-%, based on the total solid content of the first basecoat composition.

### Binders

The first basecoat composition preferably comprises—besides the at least one platelet-shaped pigment—at least one binder, more preferably at least one polymer (a1) as binder.

For the purposes of the present invention, the term “binder” is understood in accordance with DIN EN ISO 4618 (German version, date: March 2007) to be the non-volatile constituent of a coating composition, which is responsible for the film formation. The term includes crosslinkers and additives if these represent non-volatile constituents. Pigments and/or fillers contained therein are thus not subsumed under the term “binder”. Preferably, the at least one polymer (a1) is the main binder of the coating composition. As the main binder in the present invention, a binder component is preferably referred to, when there is no other binder component in the coating composition, which is present in a higher proportion based on the total weight of the coating composition.

The term “polymer” is known to the person skilled in the art and, for the purposes of the present invention, encompasses polyadducts and polymerizates as well as polycondensates. The term “polymer” includes both homopolymers and copolymers.

Preferably, the first basecoat composition is free of a copolymer BBCP as present in the coating composition used for forming coating layer L2. Thus, preferably, the first basecoat composition does not comprise any polymer that is a copolymer BBCP. The at least one polymer used as constituent (a1) may be self-crosslinking or non-self-crosslinking. Suitable polymers which can be used are, for example, known from EP 0 228 003 A1, DE 44 38 504 A1, EP 0 593 454 B1, DE 199 48 004 A1, EP 0 787 159 B1, DE 40 09 858 A1, DE 44 37 535 A1, WO 92/15405 A1 and WO 2005/021168 A1.

The at least one polymer used as constituent (a1) is preferably selected from the group consisting of polyurethanes, polyureas, polyesters, polyamides, polyethers, poly(meth)acrylates and/or copolymers of the structural units of said polymers, in particular polyurethane-poly(meth)acrylates and/or polyurethane polyureas. The at least one polymer used as constituent (a1) is particularly preferably selected from the group consisting of polyurethanes, polyesters, poly(meth)acrylates and/or copolymers of the structural units of said polymers. The term “(meth) acryl” or “(meth) acrylate” in the context of the present invention in each case comprises the meanings “methacrylic” and/or “acrylic” or “methacrylate” and/or “acrylate”.

Preferred polyurethanes are described, for example, in German patent application DE 199 48 004 A1, page 4, line 19 to page 11, line 29 (polyurethane prepolymer B1), German patent application DE 4437535 A1, example D, page 7, line 55 to page 8, line 23, in European patent application EP 0 228 003 A1, page 3, line 24 to page 5, Line 40, European Patent Application EP 0 634 431 A1, page 3, line 38 to page 8, line 9, European patent EP 0574417 B2, page 6, line 24 to line 41, and line 45 to line 47, European patent EP 0521928 B1, page 9, line 11 to line 28, and international patent application WO 92/15405, page 2, line 35 to page 10, line 32.

Preferred polyethers are, e.g., described in WO 2017/097642 A1 and WO 2017/121683 A1.

Preferred poly(meth)acrylates are, e.g., described in EP 0569907 B1, page 12, line 41 to page 13, line 4, or EP 0589340 B1, page 7, line 10 to 21 and page 8, line 3 to 16.

Preferred polyesters are described, for example, in DE 4009858 A1 in column 6, line 53 to column 7, line 61 and column 10, line 24 to column 13, line 3, EP 2421924 B1, page 16, line 50 to page 17, line 6, or WO 2014/033135 A2, page 2, line 24 to page 7, line 10 and page 28, line 13 to page 29, line 13 described. Likewise preferred polyesters are polyesters having a dendritic structure or star-shaped structure, as described, for example, in WO 2008/148555 A1.

Preferred polyurethane-poly(meth)acrylate copolymers (e.g., (meth)acrylated polyurethanes)) and their preparation are described, for example, in WO 91/15528 A1, page 3, line 21 to page 20, line 33 and in DE 4437535 A1, page 2, line 27 to page 6, line 22 described.

Preferred (meth)acrylic copolymers are OH-functional. Hydroxyl-containing monomers include hydroxy alkyl esters of acrylic or methacrylic acid, which can be used for preparing the copolymer. Non-limiting examples of hydroxyl-functional monomers include hydroxyethyl(meth)acrylate, hydroxypropyl(meth)acrylates, hydroxybutyl-(meth)acrylates, hydroxyhexyl(meth)-acrylates, propylene glycol mono(meth)acrylate, 2,3-dihydroxypropyl(meth)acrylate, pentaerythritol mono(meth)acrylate, polypropylene glycol mono(meth)acrylates, polyethylene glycol mono(meth)acrylates, reaction products of these with epsilon-caprolactone, and other hydroxyalkyl-(meth)acrylates having branched or linear alkyl groups of up to about 10 carbons, and mixtures of these. Hydroxyl groups on a vinyl polymer such as an (meth)acrylic polymer can be generated by other means, such as, for example, the ring opening of a glycidyl group, for example from copolymerized glycidyl methacrylate, by an organic acid or an amine. Hydroxyl functionality may also be introduced through thio-alcohol compounds, including, without limitation, 3-mercapto-1-propanol, 3-mercapto-2-butanol, 11-mercapto-1-undecanol, 1-mercapto-2-propanol, 2-mercaptoethanol, 6-mercapto-1-hexanol, 2-mercaptobenzyl alcohol, 3-mercapto-1,2-proanediol, 4-mercapto-1-butanol, and combinations of these. Any of these methods may be used to prepare a useful hydroxyl-functional (meth)acrylic polymer. Examples of suitable comonomers that may be used include, without limitation, α,β-ethylenically unsaturated monocarboxylic acids containing 3 to 5 carbon atoms such as acrylic, methacrylic, and crotonic acids and the alkyl and cycloalkyl esters, nitriles, and amides of acrylic acid, methacrylic acid, and crotonic acid; α,β-ethylenically unsaturated dicarboxylic acids containing 4 to 6 carbon atoms and the anhydrides, monoesters, and diesters of those acids; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic alcohols containing 1 to 20 carbon atoms, such as methyl, ethyl, propyl, isopropyl, n-butyl, isobutyl, tert-butyl, hexyl, 2-ethylhexyl, dodecyl, 3,3,5-trimethylhexyl, stearyl, lauryl, cyclohexyl, alkyl-substituted cyclohexyl, alkanol-substituted cyclohexyl, such as 2-tert-butyl and 4-tert-butyl cyclohexyl, 4-cyclohexyl-1-butyl, 2-tert-butyl cyclohexyl, 4-tert-butyl cyclohexyl, 3,3,5,5,-tetramethyl cyclohexyl, tetrahydrofurfuryl, and isobornyl acrylates, methacrylates, and crotonates; unsaturated dialkanoic acids and anhydrides such as fumaric, maleic, itaconic acids and anhydrides and their mono- and diesters with alcohols such as methanol, ethanol, propanol, isopropanol, butanol, isobutanol, and tert-butanol, like maleic anhydride, maleic acid dimethyl ester and maleic acid monohexyl ester; vinyl acetate, vinyl propionate, vinyl ethyl ether, and vinyl ethyl ketone; styrene, a-methyl styrene, vinyl toluene, 2-vinyl pyrrolidone, and p-tert-butylstyrene. The (meth)acrylic copolymer may be prepared using conventional techniques, such as by heating the monomers in the presence of a polymerization initiating agent and optionally a chain transfer agent.

Suitable poly(meth)acrylates are also those which can be prepared by multistage free-radical emulsion polymerization of olefinically unsaturated monomers in water and/or organic solvents. Examples of seed-core-shell polymers (SCS polymers) obtained in this manner are disclosed in WO 2016/116299 A1.

Preferred polyurethane-polyurea copolymers are polyurethane-polyurea particles, preferably those having a Z-average particle size of 40 to 2000 nm, the polyurethane-polyurea particles, each in reacted form, containing at least one isocyanate group-containing polyurethane prepolymer containing anionic and/or groups which can be converted into anionic groups and at least one polyamine containing two primary amino groups and one or two secondary amino groups. Preferably, such copolymers are used in the form of an aqueous dispersion. Such polymers can in principle be prepared by conventional polyaddition of, for example, polyisocyanates with polyols and polyamines.

The polymer used as constituent (a1) preferably has reactive functional groups which enable a crosslinking reaction. Any common crosslinkable reactive functional group known to those skilled in the art can be present. Preferably, the polymer used as constituent (a1) has at least one kind of functional reactive groups selected from the group consisting of primary amino groups, secondary amino groups, hydroxyl groups, thiol groups, carboxyl groups and carbamate groups. Preferably, the polymer used as constituent (a1) has functional hydroxyl groups and/or carbamate groups.

Preferably, the polymer used as constituent (a1) is hydroxyl-functional and more preferably has an OH number in the range of 15 to 400 mg KOH/g, more preferably from 20 to 250 mg KOH/g.

The polymer used as constituent (a1) is particularly preferably a hydroxyl-functional polyurethane-poly (meth) acrylate copolymer, a hydroxyl-functional polyester and/or a hydroxyl-functional polyurethane-polyurea copolymer.

In addition, the first basecoat composition may contain at least one typical crosslinking agent known per se. Crosslinking agents are to be included among the film-forming non-volatile components of a coating composition, and therefore fall within the general definition of the “binder”. Crosslinking agents are thus to be subsumed under the constituent (a1).

All conventional crosslinking agents can be used. This includes melamine resins, preferably melamine aldehyde resins, more preferably melamine formaldehyde resins, blocked polyisocyanates, polyisocyanates having free (unblocked) isocyanate groups, crosslinking agents having amino groups such as secondary and/or primary amino groups, and crosslinking agents having epoxide groups and/or hydrazide groups, as well as crosslinking agents having carbodiimide groups, as long as the functional groups of the particular crosslinking agent are suitable to be reacted with the crosslinkable functional groups of the film-forming polymers used as binders in a crosslinking reaction. For example, a crosslinking agent having blocked or free isocyanate groups can be reacted with a film-forming polymer having crosslinkable OH-groups and/or amino groups at elevated temperatures in case of 1 K formulations and at ambient temperature in case of 2K formulations.

If a crosslinking agent is present, it is preferably at least one aminoplast resin and/or at least one blocked or free polyisocyanate, preferably an aminoplast resin. Among the aminoplast resins, melamine resins such as melamine formaldehyde resins are particularly preferred. Preferably, the melamine aldehyde resins, preferably the melamine formaldehyde resins, in each case bear at least one of imino groups, alkylol groups and etherified alkylol groups as functional groups, which are reactive towards the functional groups of the binder to be crosslinked. Examples of alkylol groups are methylol groups.

### Solids Content of the First Basecoat Composition

Preferably, the total solid content of the first basecoat composition is in the range of from 10 to 65 wt.-%, more preferably of from 15 to 60 wt.-%, even more preferably of from 20 to 50 wt.-%, in particular of from 25 to 45 wt.-%, in each case based on the total weight of the first basecoat composition. The method for measuring the solid content (non-volatile content) is described in the ‘Methods’ section hereinafter.

### Coating Laver L2 and Second Basecoat Composition Used for Forming Said Layer

The second coating layer L2 is applied over the first coating layer L1. The second coating layer L2 is thus preferably positioned above coating layer L1. The second coating layer L2 is formed from a coating composition comprising at least one block copolymer BBCP. This coating composition is also referred to herein as second basecoat composition and is the composition used in step (2) of the inventive method.

The second basecoat composition may be an aqueous, i.e., waterborne, coating composition. The second basecoat composition may alternatively be a solvent-borne basecoat composition. In particular, it is, preferably, a solvent-borne basecoat composition. The basecoat composition can be 1 K- (one-component) or 2K- (two components) composition. Preferably, it is a 1 K-composition.

Preferably, the second basecoat composition is free of pigments. Preferably, the second basecoat composition is free of fillers, most preferably is free of both pigments and fillers. Alternatively, however, the coating composition comprising the at least one block copolymer BBCP is a pigmented coating composition.

Most preferably, the second basecoat composition is a solvent-borne coating composition, which is preferably free of pigments.

Preferably, the total solid content of the second basecoat composition is in a range of from 15 to 70 wt.-%, more preferably of from 20 to 65 wt.-%, even more preferably of from 25 to 60 wt.-%, in particular of from 30 to 55 wt.-%, in each case based on the total weight of the second basecoat composition. The method for measuring the solid content (non-volatile content) is described in the ‘Methods’ section hereinafter.

### Block Copolymer

The second basecoat composition necessarily comprises at least one block copolymer BBCP. As already outlined above, the inventively used block copolymer is also referred to as copolymer BBCP hereinafter and hereinbefore.

Preferably, the at least one copolymer BBCP is present in the coating composition used for preparing the second coating layer L2 in an amount in the range of from 10 to 100 wt.-%, more preferably of from 15 to 100 wt.-%, even more preferably of from 20 to 95 wt.-%, based in each case on the total solid content of the coating composition.

The at least one block copolymer BBCP contains a backbone and at least two blocks B1 and B2 being different from one another. Block B1 comprises at least one kind of side chains S1 attached to the backbone and block B2 comprises at least one kind of side chains S2 attached to the backbone, which are different from side chains S1. Since each of the side chains S1 and S2 is attached to the backbone of the inventively used copolymer BBCP and said copolymer is necessarily a block copolymer comprising the at least two blocks B1 and B2, wherein block B1 in turn comprises aforementioned side chains S1 and block B2 in turn comprises aforementioned side chains S2, it is clear that at least the part of the backbone of the inventively used copolymer, to which the side chains S1 are attached to, is also part of block B1, and that at least the part of the backbone of the inventively used copolymer, to which the side chains S2 are attached to, is also part of block B2. It is further clear that the part of block B1, which does not constitute the at least one kind of side chains S1, but to which the side chains S1 are attached to, constitutes part of the backbone of the copolymer, and that the part of block B2, which does not constitute the at least one kind of side chains S2, but to which the side chains S2 are attached to, constitutes also part of the backbone of the copolymer. Each of side chains S1 comprises at least one polymeric moiety M1 being selected from the group consisting of polyester, polyether and poly(meth)acrylate moieties, and each of side chains S2 comprises at least one polymeric moiety M2 being different from polymeric moiety M1 and being selected from the group consisting of polyester, poly(meth)acrylate, polyether, polysiloxane and polystyrene moieties. The side chains S1 and S2 are preferably covalently attached to the backbone of the block copolymer BBCP. The backbone (main chain) of copolymer BBCP preferably comprises ethylenically unsaturated carbon-carbon double bonds, but does not necessarily have to.

Copolymer BBCP is preferably obtainable by ring-opening metathesis polymerization (ROMP) using cyclic ethylenically unsaturated, preferably cyclic olefinic, monomers. ROMP is a specific olefin metathesis chain growth polymerization. The driving force of this reaction is relief of ring strain in cyclic olefins (e.g. norbornene or cyclopentene monomers).

Preferably, the backbone of copolymer BBCP comprises olefinic carbon-carbon double bonds, more preferably arranged in a regular and/or repeating pattern, even more preferably in a manner such that each structural unit described hereinafter is covalently linked to another structural unit via a carbon-carbon double bond. These double bonds are preferably formed during ROMP. If copolymer BBCP is obtained in this manner, i.e., by ROMP, the formed carbon-carbon double bonds present within the backbone may be optionally hydrogenated to saturated carbon bonds such as alkylene moieties afterwards.

A person skilled in the art is aware of methods of preparing copolymers BBCP, in particular of such copolymers prepared via ROMP: copolymers BBCP as such are known and are, e.g., disclosed in WO 2020/160299 A1, WO 2020/180427 A1 as well as in B. R. Sveinbjörnsson et al., PNAS 2012, 109 (36), p. 14332-14336. The preparation of copolymers BBCP is also described in these references and, in case of the cited journal article, also in its supporting information.

Block copolymer BBCP is preferably a linear block copolymer. Block copolymer BBCP preferably has a block-like sequence of copolymerized structural units derived at least partially from suitable ethylenically unsaturated monomers, preferably cyclic olefins. Preferably, no (meth)acrylic monomers are used for preparing block copolymer BBCP.

Block copolymer BBCP comprises at least two blocks and is thus at least a diblock copolymer, more preferably a linear diblock copolymer. However, copolymer BBCP may comprise additional block(s), e.g., may as well be a triblock copolymer.

Block copolymers are copolymers obtained by adding at least two different ethylenically unsaturated monomers, two different mixtures of ethylenically unsaturated monomers or by adding an ethylenically unsaturated monomer and a mixture of ethylenically unsaturated monomers at different times in the practice of a controlled polymerization, wherein an ethylenically unsaturated monomer or a mixture of ethylenically unsaturated monomers is initially charged at the start of the reaction. At the time of adding the further ethylenically unsaturated monomer or the mixture of ethylenically unsaturated monomers or adding ethylenically unsaturated monomers in multiple installments, the ethylenically unsaturated monomers added at the start of the polymerization can be already completely reacted, or still be partly non-polymerized. As a result of such a polymerization, block copolymers may have at least one transition in their structural units along the polymer chain (polymer backbone), said transition marking the boundary between the individual blocks. Suitable block copolymer structures are e.g., AB diblock copolymers, ABA triblock copolymers or ABC triblock copolymers. Block copolymers, which are preferably used according to the present invention, contain blocks having a minimum number of two structural units per block.

Preferably, block copolymer BBCP is of the type A-B, A-B-A, B-A-B, A-B-C and/or A-C-B, in which the A, B and C blocks represent a differing composition of structural units, wherein the blocks A, B and C differ in their respective composition of structural units and/or wherein the amount of structural units in two adjacent blocks differs from each other by more than 5% by weight in each case. Most preferred are, however, AB diblock copolymers.

Preferably, the at least one copolymer BBCP present in the second basecoat composition has a number average molecular weight (Mn) in a range of from 450 to 6000 kDa, more preferably in a range of from 500 to 2500 kDa, even more preferably in a range of from 550 to 2000 kDa, still more preferably in a range of from 600 to 1500 kDa, in particular in a range of from 650 to 1000 kDa.

The method for measuring the number average molecular weight (Mₙ) as well as for measuring the weight average molecular weight (M_{w}) and the polydispersity index (PDI) is described in the ‘Methods’ section hereinafter.

As mentioned hereinbefore each of side chains S1 comprises at least one polymeric moiety M1 being selected from the group consisting of polyester, polyether and poly(meth)acrylate moieties, and each of side chains S2 comprises at least one polymeric moiety M2 being different from polymeric moiety M1 and being selected from the group consisting of polyester, poly(meth)acrylate, polyether, polysiloxane and polystyrene moieties.

Preferably, the side chains are not introduced into copolymer BBCP after it has already been polymerized in polymer analogous reaction. Rather, the side chains are preferably introduced into suitable monomers used for the polymerization reaction to prepare copolymer BBCP. As these monomers bear the aforementioned polymeric moieties the corresponding monomers represent macromonomers.

Preferably, cyclic olefins are used for preparing copolymer BBCP, more preferably norbornene or cyclopentene monomers. Polymeric moieties such as M1 and M2 can be introduced into such monomers for instance by using norbornene or cyclopentene monomers having at least one functional group such as a carboxylic acid group and/or a hydroxyl group.

Examples of suitable norbornene monomers are

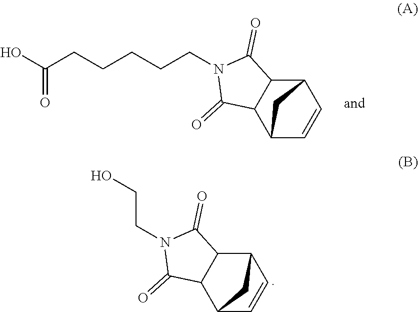 [SMILES: O=C(O)CCCCCN1C(=O)C2C(C1=O)[C@H]1C=C[C@@H]2C1 ; O=C1C2C(C(=O)N1CCO)[C@H]1C=C[C@@H]2C1]

For example, (B) can be used as initiator alcohol for a polymerization such as a tin-catalyzed polymerization of lactide such as racemic lactide to yield a polylactide macromonomer having both an OH-functional terminal group and being norbornene functionalized at its other end. The polylactide unit represents a polyester moiety as an example of polymeric moiety M1. The norbornene moiety can then be used in ROMP to prepare copolymer BBCP. The preparation of such a macromonomer is e.g., described in the supporting information of B. R. Sveinbjörnsson et al., PNAS 2012, 109 (36), p. 14332-14336. Monomer (A) can also be used for preparing suitable macromonomers suitable for ROMP. For example, a polymer such as polystyrene can be prepared having a terminal OH-group. Said terminal OH-group of this formed precursor can then be transformed into an ester bond via a reaction with (A) to yield a suitable macromonomer bearing a polystyrene moiety as polymeric moiety M2. The preparation of such a macromonomer is e.g., described in example 2 of WO 2020/180427 A1.

Preferably, each of side chains S1 of the first block B1 of copolymer BBCP comprises at least one polymeric moiety M1, which contains at least one preferably terminal hydroxyl group, wherein polymeric moiety M1 is preferably selected from the group consisting of preferably aliphatic polyester moieties, and preferably aliphatic polyether moieties, in particular represents a polylactide moiety, and, also preferably, each of side chains S2 of the second block B2 of copolymer BBCP comprises at least one polymeric moiety M2, which is free from both hydroxyl and carboxylic acid groups, wherein polymer moiety M2 is preferably selected from the group consisting of polyether, polysiloxane and polystyrene moieties, in particular represents a polystyrene moiety.

Preferably, the first block B1 of copolymer BBCP comprises at least one structural unit SU1a and optionally at least one structural unit SU1b, wherein structural unit SU1a is represented by at least one of part structures PS1a-1 and PS1a-2, and wherein optionally present structural unit SU1b is represented by part structure PS1b, wherein all structural units present in the first block are preferably arranged randomly within the first block B1 of copolymer BBCP

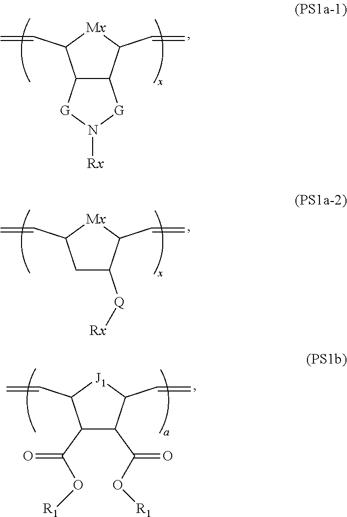

wherein independently of one another
parameter x is in a range of from 1 to 1000, preferably of from 1 to 750, more preferably of from 2 to 500, even more preferably of from 3 to 300,
parameter a is in a range of from 0 to 1000, preferably of from 1 to 750, more preferably of from 2 to 500, even more preferably of from 3 to 300,
the relative ratio of parameters x:a is in a range of from 1:0 to 1:3, preferably of from 2:1 to 1:2,
Mx, J₁ and G represent independently of one another CH₂ or C═O,
Q represents a divalent alkyl, heteroalkyl, cycloalkyl, heterocycloalkyl, aryl or heteroaryl residue,
Rx represents side chain S1 comprising polymeric moiety M1, preferably represents
C₂-C₆-alkylene-O—[C(═O)—C₂-C₆-alkylene-O]ₙ—H, wherein parameter n is in a range of from 1 to 500, preferably of from 1 to 300, and
R₁ represents a C₁-C₆-alkyl residue, preferably an unbranched C₁-C₆-alkyl residue.

Preferably, the second block B2 of copolymer BBCP comprises at least one structural unit SU2a and optionally at least one structural unit SU2b, wherein structural unit SU2a is represented by at least one of part structures PS2a-1 and PS2a-2, and wherein optionally present structural unit SU2b is represented by part structure PS2b, wherein all structural units present in the second block preferably are arranged randomly within the second block B2 of copolymer BBCP

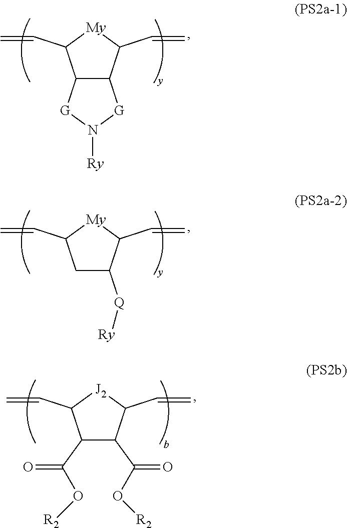

wherein independently of one another
parameter y is in a range of from 1 to 1000, preferably of from 1 to 750, more preferably of from 2 to 500, even more preferably of from 3 to 300,
parameter b is in a range of from 0 to 1000, preferably of from 1 to 750, more preferably of from 2 to 500, even more preferably of from 3 to 300, the relative ratio of parameters y:b is in a range of from 1:0 to 1:3, preferably of from 2:1 to 1:2,
My, J₂ and G represent independently of one another CH₂ or C=0,
Q represents a divalent alkyl, heteroalkyl, cycloalkyl, heterocycloalkyl, aryl or heteroaryl residue,
Ry represents side chain S2 comprising polymeric moiety M2, preferably represents C₁-C₈-alkylene-Z-T, wherein Z denotes C(═O)—O or a divalent N-containing heterocyclic residue, and T represents a C₁-C₄-alkylene residue, to which a polystyrene moiety is bonded, and
R₂ represents a C₁-C₆-alkyl residue, preferably a branched C₁-C₆-alkyl residue.

Preferably, parameters a and b are each independently 1-300, 5-50, 50-100, 100-150, 150-200, 200-250, 250-300, 300-400, 400-500, 500-600, 600-700, 700-800, 800-900, or 900-1000. Preferably, x and y are each independently 1-300, 5-50, 50-100, 100-150, 150-200, 200-250, 250-300, 300-400, 400-500, 500-600, 600-700, 700-800, 800-900, or 900-1000. Preferably, the ratio of x:a is 1:0.5 to 1:1, 1:1.5, 1:2, or to 1:2.5. Preferably, the ratio of y:b is 1:0.5 to 1:1, 1:1.5, 1:2, or to 1:2.5.

Preferably, a+x+b+y is in a range of from 100 to 500, more preferably of from 120 to 480, even more preferably of from 140 to 400, still more preferably of from 160 to 350, in particular of from 180 to 300.

The term “alkyl” refers to a branched or unbranched hydrocarbon having, for example, from 1-20 carbon atoms, and often 1-12, 1-10, 1-8, 1-6, or 1-4 carbon atoms; or for example, a range between 1-20 carbon atoms, such as 2-6, 3-6, 2-8, or 3-8 carbon atoms. Examples include, but are not limited to, methyl, ethyl, 1-propyl, 2-propyl, 1-butyl, 2-methyl- 1-propyl {isobutyl), 2-butyl (sec-butyl), 2-methyl-2-propyl (/-butyl), 1-pentyl, 2- pentyl, 3-pentyl, 2-methyl-2-butyl, 3-methyl-2-butyl, 3-methyl- 1-butyl, 2-methyl-1-butyl, 1- hexyl, 2-hexyl, 3-hexyl, 2-methyl-2-pentyl, 3-methyl-2-pentyl, 4-methyl-2-pentyl, 3-methyl- 3-pentyl, 2-methyl-3-pentyl, 2,3-dimethyl-2-butyl, 3, 3-dimethyl-2-butyl, hexyl, octyl, decyl, and dodecyl. The alkyl can be unsubstituted or substituted. The term “heterooalkyl” is preferably understood to be an alkyl as defined above with at least one heteroatom selected from nitrogen, sulfur, oxygen, and/or at least one heteroatom containing group. The term “cycloalkyl” preferably refers to cyclic alkyl groups of, for example, from 3 to 10 carbon atoms having a single cyclic ring or multiple condensed rings. Cycloalkyl groups include, by way of example, single ring structures such as cyclopropyl, cyclobutyl, cyclopentyl, cyclooctyl, or multiple ring structures such as adamantyl. The cycloalkyl can be unsubstituted or substituted. The cycloalkyl group can be monovalent or divalent and can be optionally substituted as described for alkyl groups. The cycloalkyl group can optionally include one or more cites of unsaturation, for example, the cycloalkyl group can include one or more carbon-carbon double bonds. The term “heterocycloalkyl” preferably refers to a saturated or partially saturated monocyclic, bicyclic, or polycyclic ring containing at least one heteroatom selected from nitrogen, sulfur, oxygen, preferably from 1 to 3 heteroatoms in at least one ring. Each ring is preferably from 3 to 10 membered, more preferably 4 to 7 membered. Examples of suitable heterocycloalkyls include pyrrolidyl, tetrahydrofuryl, tetrahydrothiofuranyl, piperidyl, piperazyl, tetrahydropyranyl, morpholino, 1,3-diazapane, 1,4-diazapane, 1,4-oxazepane, and 1,4-oxathiapane. The group may be a terminal group or a bridging group. The term “aryl” preferably refers to an aromatic hydrocarbon group. The aryl group can have from 6 to 30 carbon atoms, for example, about 6-10 carbon atoms. Alternatively, the aryl group can have 6 to 60 carbons atoms, 6 to 120 carbon atoms, or 6 to 240 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, and biphenyl. The aryl can be unsubstituted or optionally substituted. The term “heteroaryl” preferably refers to a monocyclic, bicyclic, or tricyclic ring system containing one, two, or three aromatic rings and containing at least one nitrogen, oxygen, or sulfur atom and/or a heteroatom containing group in an aromatic ring. The heteroaryl can be unsubstituted or substituted, for example, with one or more, and in particular one to three, substituents. Typical heteroaryl groups contain 2-20 carbon atoms in the ring skeleton in addition to the one or more heteroatoms. Examples of heteroaryl groups include, but are not limited to, 2H-pyrrolyl, 3H-indolyl, 4H-quinolizinyl, acridinyl, benzo[b]thienyl, benzothiazolyl, b-carbolinyl, carbazolyl, chromenyl, cinnolinyl, dibenzo[b,d]furanyl, furazanyl, furyl, imidazolyl, imidizolyl, indazolyl, indolisinyl, indolyl, isobenzofuranyl, isoindolyl, isoquinolyl, isothiazolyl, isoxazolyl, naphthyridinyl, oxazolyl, perimidinyl, phenanthridinyl, phenanthrolinyl, phenarsazinyl, phenazinyl, phenothiazinyl, phenoxathiinyl, phenoxazinyl, phthalazinyl, pteridinyl, purinyl, pyranyl, pyrazinyl, pyrazolyl, pyridazinyl, pyridyl, pyrimidinyl, pyrrolyl, quinazolinyl, quinolyl, quinoxalinyl, thiadiazolyl, thianthrenyl, thiazolyl, thienyl, triazolyl, tetrazolyl, and xanthenyl. Preferably, “heteroaryl” denotes a monocyclic aromatic ring containing five or six ring atoms containing carbon and 1, 2, 3, or 4 heteroatoms independently selected from non-peroxide oxygen, sulfur, and N(Z) wherein Z is absent or is H, O, alkyl, aryl, or (C₁-C₆)alkylaryl. Heteroaryl may also denote an ortho-fused bicyclic heterocycle of about eight to ten ring atoms derived therefrom, particularly a benz-derivative or one derived by fusing a propylene, trimethylene, or tetramethylene diradical thereto. As used herein, the term “substituted” or “substituent” preferably means that one or more (for example, 1-20, or 1-10, or 1, 2, 3, 4, or 5 or 1, 2, or 3 or 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound. Suitable indicated groups include, e.g., alkyl, alkenyl, alkynyl, alkoxy, halo, haloalkyl, hydroxy, hydroxyalkyl, aryl, heteroaryl, heterocyclyl, cycloalkyl, alkanoyl, alkoxycarbonyl, amino, alkylamino, dialkylamino, trifluoromethylthio, difluoromethyl, acylamino, nitro, trifluoromethyl, trifluoromethoxy, carboxy, carboxyalkyl, keto, thioxo, alkylthio, alkylsulfmyl, alkyl sulfonyl, and cyano. Additionally, non-limiting examples of substituents that can be bonded to a substituted carbon (or other) atom include F, Cl, Br, I, OR′, OC(═O)N(R′)₂, CN, CF₃, OCF₃, R′, O, S, C(═O), methylenedioxy, ethylenedioxy, N(R′)₂, SR′, SOR′, SO₂R′, SO₂N(R′)₂, SO₃R′, C(═O)R′, C(═O)C(═O)R′, C(═O)CH₂C(═O)R′, C(═S)R′, C(═O)OR′, OC(═O)R′, C(═O)N(R′)₂, OC(═O)N(R′)₂, C(═S)N(R′)₂, (CH₂)₀₋₂NHC(═O)R′, N(R′)N(R′)C(═O)R′, N(R′)N(R′)C(═O)OR′, N(R′)N(R′)CON(R′)₂, N(R′)SO₂R′, N(R′)SO₂N(R′)₂, N(R′)C(═O)OR′, N(R′)C(═O)R′, N(R′)C(S)R′, N(R′)C(═O)N(R′)₂, N(R′)C(S)N(R′)₂, N(COR′)COR′, N(OR′)R′, C(═NH)N(R′)₂, C(═O)N(OR′)R′, or C(═NOR′)R′, wherein R′ can be hydrogen or a carbon-based moiety.

As the backbone of copolymer BBCP preferably comprises ethylenically unsaturated carbon-carbon double bonds, the structural units present in each block are preferably covalently linked in such a manner that each of the units is linked to another unit via a carbon-carbon double bond. Copolymer BBCP further preferably comprises two end groups in case it is linear, which is preferred. Each of these end groups is covalently bonded to one structural unit. The end groups of the copolymer (i.e., the initiator end or terminal end), preferably are low molecular weight moieties (e.g., under 500 Da), such as, H, OH, COOH, CH₂OH, CN, NH₂, or a hydrocarbon such as an alkyl (for example, a butyl or 2-cyanoprop-2-yl moiety at the initiator and terminal end), alkene or alkyne, or a moiety as a result of an elimination reaction at the first and/or last repeat unit in the copolymer.

Preferably, the block copolymer BBCP is a brush block copolymer. A brush block copolymer comprises a main chain (backbone) with linear, unbranched side chains. The brushes are often characterized by the high density of grafted chains. The limited space then leads to a strong extension of the side chains.

Preferably, the first block B1 of copolymer BBCP comprises at least one structural unit SU1a represented at least by part structure PS1a-1, and further comprises at least one structural unit SU1b represented by part structure PS1b, and the second block B2 of copolymer BBCP comprises at least one structural unit SU2a represented at least by part structure PS2a-1, and further comprises at least one structural unit SU2b represented by part structure PS1b,
wherein independently of one another
parameter x is in a range of from 2 to 500, preferably of from 3 to 300,
parameter a is in a range of from 2 to 500, preferably of from 3 to 300, the relative ratio of parameters x:a is in a range of from 2:1 to 1:2, preferably of from 1.5:1 to 1:1.5,
parameter y is in a range of from 2 to 500, preferably of from 3 to 300,
parameter b is in a range of from 2 to 500, preferably of from 3 to 300,
the relative ratio of parameters y:b is in a range of from 2:1 to 1:2, preferably of from 1.5:1 to 1:1.5, and the remaining residues and variables have one or more of the meanings defined hereinbefore.

Preferably, the coating composition comprising the at least one block copolymer BBCP used for preparing the second coating layer L2 further comprises at least one preferably linear homopolymer, more preferably at least one homopolymer selected from polyester, poly(meth)acrylate, polyether, polysiloxane and polystyrene homopolymers, still more preferably selected from polystyrene, poylether and polyester homopolymers and mixtures thereof, even more preferably selected from polystyrene and aliphatic polyesters such as polylactide homopolymers and mixtures thereof, wherein the at least one homopolymer preferably has a number average molecular weight (Mₙ), which is at least 100 times, preferably at least 150 times, more preferably at least 175 times, lower than the number average molecular weight (Mₙ) of the at least one copolymer BBCP, and wherein preferably the relative weight ratio of the BBCP copolymer solids to the solids of the at least one homopolymer within the coating composition is in a range of from 99:1 to 5:95, more preferably of from 95:5 to 10:90, even more preferably of from 90:10 to 15:85, still more preferably of from 85:15 to 20:80, yet more preferably of from 75:25 to 25:75, in particular of from 60:40 to 30:70. The method for measuring the number average molecular weight (Mₙ) as well as for measuring the weight average molecular weight (M_{w}) and the polydispersity index (PDI) is described in the ‘Methods’ section hereinafter.

Methods of preparing such homopolymers are e.g. disclosed in WO 2020/160299 A1 (pages 25/26, example 1) and WO 2020/180427 A1 (pages 25/26, example 1).

Preferably, the at least one homopolymer is present in the second basecoat composition in an amount in the range of from 0 to 90 wt.-%, preferably of from 20 to 80 wt.-%, more preferably of from 40 to 60 wt.-%, in particular of from 30 to 70 wt.-%, based in each case on the total solid content of the second basecoat composition.

Preferably, the relative weight ratio of the BBCP copolymer solids to the solids of said at least one homopolymer within the second basecoat composition is in a range of from 99:1 to 5:95, preferably of from 95:5 to 10:90, more preferably of from 90:10 to 15:85, even more preferably of from 85:15 to 20:80, yet more preferably of from 75:25 to 25:75, in particular of from 60:40 to 30:70.

Preferably, the coating composition comprising the at least one block copolymer BBCP used for preparing the second coating layer L2 comprises at least one further resin, more preferably at least one polymer resin, besides copolymer BBCP and besides the at least one homopolymer as defined above if such a homopolymer is present, wherein the relative weight ratio of the BBCP copolymer solids to the solids of the at least one further resin within the coating composition is preferably in a range of from 5:95 to 100:0, more preferably of from 10:90 to 100:0, even more preferably of from 15:85 to 95:5, still more preferably of from 20:80 to 90:10, yet more preferably of from 25:75 to 85:15, in particular of from 30:70 to 80:20, most preferably of from 40:60 to 80:20.

Preferably, the coating composition comprising the at least one block copolymer BBCP used for preparing the second coating layer L2 comprises, besides copolymer BBCP and besides the at least one homopolymer as defined hereinbefore—if such a homopolymer is present—wherein the relative weight ratio of the sum of BBCP copolymer solids and homopolymer solids—if present—to the solids of the at least one further resin within the topcoat composition is preferably in a range of from 40:60 to 100:0, more preferably of from 45:55 to 100:0, even more preferably of from 50:50 to 95:5, still more preferably of from 55:45 to 90:10, yet more preferably of from 60:40 to 85:15.

### Binders

The at least one further resin, preferably the at least one polymer resin, which is optionally present in the second basecoat composition besides copolymer BBCP and besides the at least one homopolymer of present, preferably functions as at least one binder (b1). The same binders including crosslinkers (i.e., crosslinking agents) described hereinbefore in connection with constituent (a1) and described hereinafter in connection with constituent (c1) can also be used as constituent (b1). The optionally present at least one polymer constituent (b1) is, of course, different from copolymer BBCP and from the aforementioned homopolymer.

### Coating Layer L3 and Coating Composition Used for Forming Said Layer

The third coating layer L3 is applied over the second coating layer L2. The third coating layer L3 is thus preferably positioned above coating layer L2 and in direct contact with layer L2.

Preferably, the third coating layer L3 is a clearcoat layer formed from a coating composition, which is a clearcoat composition, preferably a solvent-borne clearcoat composition, wherein the third coating layer L3 preferably is the outermost coating layer of the multilayer coating system. This coating composition is also referred to herein as topcoat composition and is the composition used in step (3) of the inventive method.

The topcoat composition may be an aqueous, i.e., waterborne, coating composition. It may alternatively be a solvent-borne basecoat composition. In particular, it is, in fact, a solvent-borne clearcoat composition. The topcoat composition can be 1 K- (one-component) or 2K- (two components) composition.

Preferably, the total solid content of the topcoat composition is in the range of from 10 to 65 wt.-%, more preferably of from 15 to 60 wt.-%, even more preferably of from 20 to 50 wt.-%, in particular of from 25 to 45 wt.-%, in each case based on the total weight of the topcoat composition.

The topcoat composition preferably comprises at least one binder, more preferably at least one polymer (c1) as binder. The same binders including crosslinkers described above in connection with constituents (a1) and (b1) can also be used as constituent (c1).

Preferably, the topcoat composition comprises at least one polymer (c1) having on average two or more OH-groups and/or amino groups and/or carbamate groups, more preferably OH-groups and/or carbamate groups. Preferably, the at least one preferably at least OH- and/or carbamate functional polymer (c1) has a weight average molecular weight M_{w}, measured by means of gel permeation chromatography (GPC) against a polystyrene standard, preferably between 800 and 100 000 g/mol, more particularly between 1000 and 75 000 g/mol.

If the topcoat composition is formulated as a 2K coating composition it preferably contains as at least one further polymer (c1) being present therein at least one polyisocyanate having free NCO-groups as crosslinker. If the topcoat composition is formulated as a 1 K coating composition it preferably contains as at least one further polymer (c1) being present therein at least one polyisocyanate having blocked NCO-groups and/or at least one melamine formaldehyde resin as crosslinker.

Suitable constituents (c1) for use as crosslinkers are organic constituents bearing on average two or more NCO-groups. The at least one organic constituent used as crosslinker preferably has a cycloaliphatic structure and/or a parent structure that is derived from a cycloaliphatic polyisocyanate by trimerization, dimerization, urethane formation, biuret formation, uretdione formation and/or allophanate formation. Alternatively, or additionally, the at least one organic constituent used as crosslinker preferably has an acyclic aliphatic structure and/or a parent structure that is derived from an acyclic aliphatic polyisocyanate by trimerization, dimerization, urethane formation, biuret formation, uretdione formation and/or allophanate formation. The acyclic aliphatic polyisocyanates—optionally serving as parent structures—are preferably substituted or unsubstituted aliphatic polyisocyanates that are known per se. Examples are tetramethylene 1,4-diisocyanate, hexamethylene 1,6-diisocyanate, 2,2,4-trimethylhexane 1,6-diisocyanate, ethylene diisocyanate, dodecane 1,12-diisocyanate, and mixtures of the aforementioned polyisocyanates. The cycloaliphatic polyisocyanates—optionally serving as parent structures—are preferably substituted or unsubstituted cycloaliphatic polyisocyanates which are known per se. Examples of preferred polyisocyanates are isophorone diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate, hexahydrophenylene 1,3-diisocyanate, hexahydrophenylene 1,4-diisocyanate, perhydrodiphenylmethane 2,4′-diisocyanate, 4,4′-methylendicyclohexyl diisocyanate (e.g. Desmodur® W from BayerAG) and mixtures of the aforementioned polyisocyanates. The organic constituents bearing on average two or more NCO-groups mentioned above can also be partially be silanized. Such silanized crosslinking agents are e.g., disclosed in WO 2010/063332 A1, WO 2010/139375 A1 and WO 2009/077181 A1.

Suitable constituents (c1) for use as crosslinkers in particular in case the topcoat compositions are formulated as 1K coating compositions are melamine formaldehyde resins. The same melamine formaldehyde resins can be used which have already been discussed hereinbefore in connection with constituent (a1).

Preferably, the topcoat composition 3) is free of a copolymer (BBCP) as present in the second basecoat composition.

The topcoat composition may be non-pigmented. The topcoat composition, even when it is formulated as a clearcoat composition, however, may alternatively contain coloring and/or effect pigments, preferably coloring pigments, in such amounts that do not interfere with the desired transparency of the clearcoat once cured. For examples, the clearcoat composition may contain up to 7.5 wt.-%, preferably up to 5.0 wt.-%, more preferably up to 2.5 wt.-%, still more preferably up to 1.5 wt.-% of at least one coloring pigment, in each case based on the total solid content of the clearcoat composition. The same applies to optionally present fillers within the clearcoat composition. Preferably, however, the clearcoat composition is free of pigments and/or fillers.

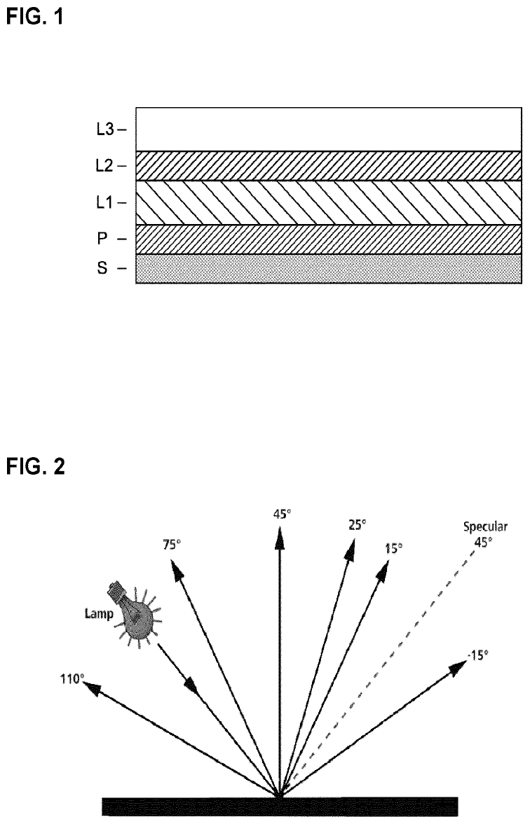

An inventive multilayer coating system, comprising layers L1, L2 and L3, which is on top of a substrate S which is precoated with a primer P, is exemplified in FIG. 1.

### Inventive Method

The inventive method is a method of preparing the inventive multilayer coating system onto an optionally pre-coated substrate comprising at least steps (1), (2), (3) and (4).

The inventive method is both suitable for automotive OEM and refinish applications, in particular for automotive OEM applications.

Preferably, each of steps (1) to (3) is performed via spray application.

At least the second and third coating films, but optionally also the first coating film, are at this stage—after having performed the respective step(s)—preferably each uncured coating films. Thus, at least the coating composition applied in step (3) is preferably applied wet-on-wet onto the second coating film obtained after having performed step (2). If only the resulting second and third coating films are jointly cured, the first coating film applied in step (1) is cured before step (2) is performed. Alternatively, however, also the coating composition applied in step (2) is preferably applied wet-on-wet on the first coating film obtained after having performed step (1). In this case, when step (2) is performed the first coating film is still an uncured coating film. If the resulting first, second and third coating films are jointly cured in step (4), the inventive method is a wet-on-wet-on-wet method.

### Step (1)

According to step (1) a first basecoat composition comprising at least one kind of a platelet-shaped pigment is applied to at least a portion of an optionally pre-coated substrate and a first coating film is formed on at least a portion of the optionally pre-coated substrate. The basecoat composition used in step (1) of the inventive method is also referred to as “first basecoat composition”.

### Optional Step (1a)

Preferably, the inventive method further comprises a step (1a), which is carried out after step (1) and before step (2). In said step (1a) the first coating film obtained after step (1) is flashed-off before applying the second basecoat composition in step (2), preferably for a period of 1 to 20 minutes, more preferably for a period of 2 to 15 minutes, in particular for a period of 5 to 10 minutes. Preferably, step (1a) is performed at a temperature not exceeding 80° C., more preferably at a temperature in the range of from 30° C. to 60° C.

The term “flashing off” in the sense of the present invention preferably means at least partially “drying”, wherein at least some of the solvents (water and/or organic solvent(s)) are evaporated from the coating film, before the next coating composition is applied and/or curing is carried out. Preferably, no curing or at least not complete cure is performed by the flashing-off.

Optional step (1b)

Preferably, the inventive method further comprises a step (1b), which is carried out after step (1) or step (1a) and before step (2). In said step (1b) the first coating film obtained after step (1) or (1a) is cured before applying the second basecoat composition in step (2). The same curing conditions can be used/applied that are outlined in detail hereinafter in connection with step (4).

Preferably, steps (1a) and/or (1b) are performed. More preferably, at least step (1b) is performed so that the second basecoat composition applied in step (2) is applied onto a cured first coating film.

### Step (2)

According to step (2) a second basecoat composition comprising the at least one block copolymer BBCP and being different from the basecoat composition applied in step (1) is applied to the first coating film present on the substrate obtained after step (1) and a second coating film is formed, which preferably is adjacent to the first coating film.

Step (2) can be performed prior to curing the first coating film obtained after step (1). Alternatively, and preferably, step (2) is performed after curing the first coating film obtained after step (1), i.e., after having performed at least optional step (1b).

### Optional Step (2a)

Preferably, the inventive method further comprises a step (2a), which is carried out after step (2) and before step (3). In said step (2a) the second coating film obtained after step (2) is flashed-off before applying the topcoat composition in step (3), preferably for a period of 1 to 20 minutes, more preferably for a period of 2 to 15 minutes, in particular for a period of 5 to 10 minutes. Preferably, step (2a) is performed at a temperature not exceeding 40° C., more preferably at a temperature in the range of from 18 to 30° C.

### Step (3)

According to step (3) a coating composition different from the compositions applied in steps (1) and (2) is applied to the second coating film present on the substrate obtained after step (2) and a third coating film is formed, which is preferably adjacent to the second coating film, wherein said coating composition is a topcoat composition and preferably is a clearcoat composition.

Preferably, the third coating film obtained after step (3) is the outermost film of the formed multilayer coating system.

### Optional Step (3a)

Preferably, the inventive method further comprises a step (3a), which is carried out after step (3) and before step (4). In said step (3a) the third coating film obtained after step (3) is flashed-off before performing curing step (4), preferably for a period of 1 to 20 minutes, more preferably for a period of 2 to 15 minutes, in particular for a period of 5 to 10 minutes. Preferably, step (3a) is performed at a temperature not exceeding 40° C., more preferably at a temperature in the range of from 18 to 30° C.

### Step (4)

According to step (4) at least the second and third coating films applied in steps (2) and (3) and optionally also the first coating film applied in step (1)—in case said first coating film was not cured prior to performing of step (2)—are jointly cured, i.e. simultaneously cured, to obtain a multilayer coating system comprising at least the first, the second and the third coating layers L1, L2 and L3. Each resulting cured coating film represents a coating layer.

Preferably, step (4) is performed at a temperature less than 180° C., preferably less than 160° C., more preferably less than 150° C., in particular at a temperature in the range of from 15 to <180° C. or of from 15 to <160° C., for a period of 5 to 45 minutes, preferably for a period of 20 to 45 minutes, in particular for a period of 25 to 35 minutes. Preferably, however, the minimum curing temperature applied in step (4) is at least 80° C. In this case, curing according to step (4) is preferably performed at a temperature in the range of from 80 to <180° C. or of from 80 to <160° C.

Preferably, curing according to step (4) is selected from chemical curing such as chemical crosslinking, radiation curing, and/or physically drying (non-chemical curing), in each case at room temperature or at an elevated temperature, more preferably is selected from chemical curing, such as chemical crosslinking, and/or physically drying (non-chemical curing), in each case at room temperature or at an elevated temperature, in each case preferably wherein the minimum curing temperature applied in step (4) is at least 80° C.

### Inventive Coated Substrate

A further subject-matter of the present invention is a coated substrate obtainable by the inventive method.

All preferred embodiments described hereinabove in connection with the inventive method and the inventive multilayer coating system are also preferred embodiments with regard to the aforementioned inventive coated substrate.

### Methods

### 1. Determining the Non-Volatile Fraction

The amount of solid content (non-volatile matter, solid fraction) including the total solid content is determined via DIN EN ISO 3251:2019-09 at 110° C. for 60 min.

2. Measurement of Mₙ, M_{w} and PDI

The polymer molecular weights (number average molecular weight (Mₙ) and weight average molecular weight (M_{W})) and molecular weight distributions (PDI; polydispersity index) were determined via gel permeation chromatography (GPC) using a combination of differential refractive index (dRI) and two light scattering (LS) detectors. The use of LS detectors enables analysis of the absolute molecular weight for polymer samples. The solvent for all samples was tetrahydrofuran (THF), with the elution rate of 1.0 mL/minute. Polymer samples were fully dissolved in HPLC grade THF at concentrations ranging from 2.5-7.5 mg/mL, passed through 0.5 um syringe filters, and injected via autosampler. The porous column stationary phase consisted of two Malvern T600 single pore columns with exclusion limits of 20,000,000 Da for poly(styrene). Molecular weights and PDI were determined via OMNISEC software.

### 3. Determination of L*, a*, b*, C* and h Values

The color data of the three-layer coatings were determined by use of a Byk Mac i instrument (from Byk Gardner GmbH, Germany). The illumination was a D65 illumination (observer angle 10°). The multi-angle (viewing angles: −15°, +15°, +25°, +45°, +75°, +110°) measurement geometry is shown in FIG. 2. The angle of 110° is also denoted as “flop angle”.

By use of the afore-mentioned instrument the L*, a* and b* values of the two-layer coatings and the three-layer coatings were determined. C* is calculated by use of the following equation: C*=(a²+b²)^{0.5} and h=arctan (b/a).

The CIELAB formula defines a color space that is characterized by an a*-axis, that goes from green to red, and by a b*-axis, extending from blue to yellow, as well as a lightness axis L*, that is perpendicular to the other two. Negative values of b* mean that the color is bluish, while positive values of b* stand for a more yellowish color. High values for L* (i.e., lightness) stand for lighter colors, while low values of L* stand for darker colors.

### 4. Determination of the Dry-Laver Thickness of the Coating Layers

The dry-layer thickness of the coating layer of the present invention was determined by use of an Elcometer such as a Fischer Dualscope FMP20C.

### EXAMPLES

The following examples further illustrate the invention but are not to be construed as limiting its scope. ‘Pbw’ means parts by weight. If not defined otherwise, ‘parts’ means ‘parts by weight’ and all ‘percentage’ values are in ‘weight-%’, if not indicated otherwise.

### Preparation of an Inventively Used Copolymer

To a 2000 mL vessel under inert atmosphere, a norbornene functionalized polylactide macromonomer (PLA-MM) (29.14 mmol, having an Mₙ of 3.26 kDa) and d,x-DME (dimethyl-5-norbornene-2,3-dicarboxylate with d=endo and x=exo) were added in equimolar amounts in dichloromethane. PLA-MM was prepared prior via a tin-catalyzed ring opening polymerization of lactide using a norbornene alcohol initiator yielding an OH-functional and norbornene functionalized polylactide macromonomer PLA-MM. PLA-MM was prepared in the general manner as described within the supporting information of B. R. Sveinbjörnsson et al., PNAS 2012, 109 (36), p. 14332-14336. A bis-bipyridine ruthenium catalyst was then rapidly added to the mixture of PLA-MM and d,x-DME to initiate copolymerization, targeting PLA₁₀₀-r-DME₁₀₀. “r” means that the two monomeric units PLA and DME are arranged randomly. The mixture was stirred for 45 minutes at room temperature (first block mixture). In a separate vessel under inert atmosphere, a solution of a norbornene functionalized polystyrene macromonomer (PS-MM; having an Mₙ of 3.83 kDa) and d,x-DIPE (diisopropyl-5-norbornene-2,3-dicarboxylate with d=endo and x=exo) was prepared in dichloromethane (second block mixture). PS-MM was prepared prior in two steps in the general manner as described within example 2 of WO 2020/180427 A1: an OH-functional polymerized precursor of PS-MM was prepared by polymerization of styrene in toluene and sec-butyl lithium as initiator. After chain termination by addition of propylene oxide, followed by methanol, quenching was performed. Then, the terminal OH-group of the formed precursor was transformed into an ester bond via a reaction with a norbornene carboxylic acid to yield PS-MM. The solution of PS-MM and d,-DIPE was added to the first block reaction mixture rapidly. The two monomeric units PS and DIPE are arranged randomly within the formed second block of the copolymer. The resulting mixture was allowed to stir at room temperature for an additional 4 h and then quenched by adding ethyl vinyl ether. Then, quenched catalyst was scavenged using functionalized silica gel absorbent and it was stirred for about 4 h. The mixture was filtered and the solution concentrated under reduced pressure. The solid copolymer was obtained after the solvent is removed. It was dried in a vacuum oven for 4 hours at 75 C to remove residual solvent. The product obtained (BBCP1) was used in this form.

BBCP1 had a number average molecular weight (Mₙ) of 788.3 kDa and a weight average molecular weight (M_{w}) of 865.7 kDa. The polydispersity index (PDI) was 1.10 accordingly.

### Preparation of the Coating Compositions

To illustrate the unique coloristic properties of the brush block copolymers and to give non-limiting examples of the possibilities of color spaces attainable with the brush block copolymers, three varying colors were generated with layering the brush block copolymer-containing second basecoat layer over three different first basecoat layers given as A, B, and C made with conventional pigments and effect pigments. The combination of metallic or pearlescent effect coatings layered together with the brush block copolymers yield unique and aesthetically pleasing colors.

### First Basecoat Compositions According to the Invention

First basecoat compositions A and B and C as used in the present invention (inventive step layering) are aqueous one-pack compositions, each comprising a combination of the following platelet-shaped interference pigments with a pigment paste of carbon black:
a flake-shaped titanium dioxide coated silica effect pigment (Colorstream T20-04 WNT Lapis Sunlight); or
a flake-shaped organic blue pigment coated aluminum pigment (Friend Color D462 BL); or
a flake-shaped titanium dioxide coated non-fluorinated mica effect pigment (Pyrisma T81-23 SW Liquid Blue)

The exact compositions are shown in Table 2.

### Second Basecoat Composition According to the Invention

To generate the inventive colors, first basecoat compositions A, B, and C were each coated with a second basecoat composition D containing a brush block copolymer.

This second basecoat composition was obtained by preparing a solution of 1.50 g BBCP1, 0.75 g of a polystyrene homopolymer (PS-HP), 0.75 g of a polylactide homopolymer (PLA-HP) and 7 g n-butyl acetate. The relative weight ratio of BBCP1 solids to combined solids of PS-HP and PLA-HP in BC3 was 50:50.

### Third Coating Composition (Clear Coat) According to the Invention

As clearcoat, the commercial high solids Uregloss® clearcoat (R10CG392D; from BASF Corp. USA) was used.

### Comparative Second Basecoat Composition

To illustrate the unique color space attained by the above layering, a set of separate control experiments were carried out in which the inventive first basecoat compositions A, B, and C were coated with a non-inventive second basecoat composition E (see Table 4), which contains traditional pigments, in an attempt to match the color space as closely as possible.

In this scheme, (A+D), (B+D), and (C+D), each plus inventive clear coat were compared to the comparative colors generated by (A+E), (B+E), and (C+E), each plus inventive clear coat, respectively.

### Further Comparative Examples

Additionally, another set of control experiments was carried out, whereby an attempt was made to match the inventive color spaces by using traditional pigments and effect pigments in multiple combinations. The comparative compositions F, G, and H (see Table 3) are aqueous one-pack compositions, each comprising platelet-shaped effect pigments in combination with non-platelet shaped organic and inorganic pigments, the latter being incorporated into the composition in form of pigment pastes as described in Table 1.

Coating compositions F, G, and H represent an attempt to match the coloristic properties of the three inventive multilayered coating compositions derived from using inventive first basecoat compositions A, B, and C layered with the inventive second basecoat composition D.

Coating compositions F, G, and H are non-hiding compositions applied over a black primer and attempt to match the color of (A+D), (B+D), and (C+D), respectively. In this scheme, (A+D), (B+D), and (C+D) were compared to the comparative colors generated by (black primer+F), (black primer+G), and (black primer+H), respectively. The composition of the black primer is not particularly limited, and several grades may be used. The lightness-darkness value of the black primer L* used in the examples is 8. In all further comparative examples, the inventive clearcoat was also applied as top coat.

The ingredients of compositions A, B, C, E, F, G, and H are shown in Tables 1 to 4.

### Application of Multilayer Coating (Two and Three-Layer Coatings) Films

The first inventive basecoat compositions A, B, C, and comparative basecoat compositions F, G, and H were applied onto a baked primer layer by pneumatic hand application to form a basecoat layer having a dry-layer thickness of approx. 20 μm (basecoat layers L1, i.e., L1(A), L1(B) and L1(C), respectively, from basecoat compositions A, B and C, respectively) and a coating layer thickness of approx. 18 μm (coating layers F and G from basecoat compositions F and G, respectively) and a coating layer thickness of approx. 14 μm (coating layer H from coating composition H).

In one set of examples, on top of the basecoat layers L1(A), L1(B), and L1(C), a second basecoat composition D was applied to form layer L2(D), after a 1- to 3-minute flash, wet on wet with pneumatic hand application and on top of basecoat layers L1(A), L1(B), and L1(C), respectively. A non-inventive second basecoat composition E was applied, after a 1- to 3-minute flash, by pneumatic hand application to form a second basecoat layer E. The dry-layer thickness of the inventive second basecoat layer L2(D) was approx. 12 μm and the dry-layer thickness of the non-inventive second basecoat layer E was 5 μm.

In another set of examples, the non-inventive first basecoat coating layers F, G, and H did not have a second basecoat layer applied over them.

Subsequently the one-component clearcoat composition was pneumatically hand applied, after a 3- to 5-minute heated (63° C.) flash-off. The clearcoat was a one-component polyurethane paint applied to a dry-layer thickness of approx. 40-55 μm.

The thus coated panel was flashed-off for 5 to 10 minutes and then cured at 130° C. for 25 minutes.

TABLE 1
Pigment Pastes PP1 to PP9

| | Amounts by weight | | | | | | | | |
|---|---|---|---|---|---|---|---|---|---|
| Pigment Paste Ingredients | PP1 | PP2 | PP3 | PP4 | PP5 | PP6 | PP7 | PP8 | PP9 |
| Monarch ® 1300 (carbonblack) | 8.8 | — | — | — | — | — | — | — | — |
| Palomar ® Turquoise 264-4900 | — | 15.0 | — | — | — | — | — | — | — |
| (phthalocyanine pigment) | | | | | | | | | |
| TiPure R706 (titanium dioxide) | — | — | — | 69.0 | — | — | — | — | — |
| Tayca MT500 HD (TiO₂) | — | — | 33.4 | — | — | — | — | — | — |
| Daipyroxide Green 9320 | — | — | — | — | 35.6 | — | — | — | — |
| (cobalt titanate spinel) | | | | | | | | | |
| Palomar ® Blue 248-4806 | — | — | — | — | — | — | 25.6 | — | — |
| (phthalocyanine pigment | | | | | | | | | |
| Monarch ® 900 (carbon black) | — | — | — | — | — | 14.0 | — | — | — |
| Heliogen ® Blue L6700F | — | — | — | — | — | — | — | — | 33.0 |
| (phthalocyanine pigment) | | | | | | | | | |
| Hostaperm ® Violet BL 01 | — | — | — | — | — | — | — | 18.0 | — |
| (carbazole pigment) | | | | | | | | | |
| Acrylic Dispersant Resin A¹ | — | — | — | 6.2 | — | — | — | — | — |
| (35.5 wt % solids, 29 wt. % | | | | | | | | | |
| propylene glycol propyl ether, | | | | | | | | | |
| 29 wt. % H₂O, 6.5 wt. % ketone) | | | | | | | | | |
| Acrylic Disperant Resin B² | 27.5 | — | — | — | — | 30.3 | 24.8 | — | — |
| (35.5 wt % solids, 29 wt. % | | | | | | | | | |
| propylene glycol propyl ether, | | | | | | | | | |
| 29 wt. % H₂O, 6.5 wt. % ketone) | | | | | | | | | |
| PU dispersion C³ (32.4 wt % | — | 24.3 | — | — | — | — | — | — | — |
| solids, 7 wt % ethylene glycol | | | | | | | | | |
| butyl ether, 0.3 wt % ketone, | | | | | | | | | |
| 60.3 wt % H₂O) | | | | | | | | | |
| PU dispersion D⁴ (44 wt. % PU | — | — | 52.6 | — | 50.5 | 3.4 | — | 57.0 | 42.0 |
| solids, 56 wt. % H₂O) | | | | | | | | | |
| Water | 54.8 | 52.8 | 8.9 | 23.6 | 6.3 | 46.5 | 49.6 | 20.0 | 17.0 |
| Propylene glycol ether | 7.3 | — | 2.5 | 1.2 | — | 1.7 | — | — | — |
| Ethylene glycol butyl ether | — | 5.2 | — | — | — | — | — | — | — |
| 2-Butanone | — | 0.2 | — | — | — | — | — | — | — |
| Agitan 281 | — | — | — | — | 0.1 | — | — | — | — |
| Disperbyk 184 | — | — | 2.5 | — | 4.3 | — | — | 5.0 | 5.0 |
| N,N-dimethylethanolamine | — | 0.1 | — | — | — | — | — | — | — |
| N,N-dimethylethanolamine | 1.6 | — | 0.1 | — | — | 0.1 | — | — | — |
| (20 wt.-% in water) | | | | | | | | | |
| Pluricol ® P-1010 (BASF SE) | — | — | — | — | — | 4.0 | — | — | — |
| (colloidal agent) | | | | | | | | | |
| Pluriol ® P-900 (BASF SE) | — | 2.4 | — | — | 3.2 | — | — | — | 3.0 |
| (colloidal agent) | | | | | | | | | |
| Sum | 100 | 100 | 100 | 100 | 100 | 100 | 100 | 100 | 100 |

¹Acrylic Dispersant Resin A: preparation according to EP 0569907 B1, p. 12, I. 41 to p. 13, I. 4.
²Acrylic Dispersant Resin B: preparation according to EP 0589340 B1, p. 7, II. 10-21 and p. 8, II. 3-16.
³PU Dispersion C: preparation according to EP 0574417 B2, p. 6, II. 24-41 and II. 45-47.
⁴PU Dispersion D: preparation according to EP 0521928 B1, p. 9, II. 11-28.

TABLE 2
Inventive First Basecoat Compositions A, B and C

| 1^{st} Basecoat | | Amounts by weight | | |
|---|---|---|---|---|
| Composition A, B, C | Ingredients | A | B | C |
| | PU dispersion B⁶ (35.5 wt. % PU, 8.8 wt. % butyl glycol, 55.7 wt. % H₂O) | 5.2 | 5.1 | 5.2 |
| | PU dispersion A⁵ (27 wt. % PU solids, 4 wt. % ketone, 4 wt. % Pluricol P1010, 65 wt. % H₂O) | 42.1 | 40.8 | 42.1 |
| | BYK 345 | 0.2 | 0.2 | 0.2 |
| | Carbon Black Dispersion PP1 | 4.8 | 3.1 | 4.8 |
| | 3.5 wt. % Laponite RD + 3.5 wt. % Pluricol P1010 in H₂O (thickener) | 27.4 | 26.6 | 27.4 |
| | Tinuvin ™ 1130 | 0.3 | 0.3 | 0.3 |
| | Resimene ® HM 2608 (melamine crosslinker) | 4.0 | 3.9 | 4.0 |
| | N,N-dimethylethanolamine | 0.1 | 0.1 | 0.1 |
| Organic Phase | Pyrisma ® T81-23 SW Liquid Blue from Merck KGaA | — | — | 5.1 |
| | Friend Color ® D462 BL from Toyo Aluminum KK (55% in 45% aromatic solvent) | — | 9.3 | — |
| | Colorstream ® T20-04 WNT Lapis Sunlight from Merck KGaA | 5.1 | — | — |
| | Butyl glycol | 7.9 | 7.6 | 7.9 |
| | Polyester resin A⁷ | 2.5 | 2.5 | 2.5 |
| | Passivator VP 71566/G from Altana | — | 0.2 | — |
| | N,N-dimethylethanolamine (20 wt.-% in water) | 0.3 | 0.3 | 0.3 |

| | | | |
|---|---|---|---|
| Sum | 100.0 | 100.0 | 100.0 |

⁵PU Dispersion A: preparation according to EP 0574417 B2, p. 6, II. 24-41.
⁶PU Dispersion B: preparation according to DE 4437535 A1, example D, p. 7, I. 55 to p. 8, I. 23.
⁷Polyester resin A: preparation according to EP 2421924 B1, p. 16, I. 50 to p. 17, I. 6.

TABLE 3
Comparative Coating Compositions F, G, H

| | | Amounts by weight | | |
|---|---|---|---|---|
| Compositions F, G, H | Ingredients | F | G | H |
| | Daotan ® VTW 6462/36WA | 6.1 | 6.2 | 6.2 |
| | PU dispersion B⁶ (35.5 wt. % PU, 8.8 wt. % butyl glycol, 55.7 wt. % H₂O) | 5.3 | 5.3 | 5.2 |
| | PU dispersion A⁵ (27 wt. % PU solids, 4 wt. % ketone, 4 wt. % Pluricol P1010, 65 wt. % H₂O) | 15.8 | 21.1 | 22.0 |
| | Water | 19.3 | 19.4 | 19.0 |
| | Pluricol P1010 | 1.0 | 1.0 | 1.0 |
| | Phthalocyanine Blue Dispersion PP2 | 1.6 | 2.3 | 3.7 |
| | Titanium Dioxide Dispersion PP3 | 10.2 | — | — |
| | Titanium Dioxide Dispersion PP4 | — | 0.2 | 0.6 |
| | Cobalt Green Dispersion PP5 | — | 3.3 | — |
| | Phthalocyanine Blue Dispersion PP7 | — | — | 1.2 |
| | TMDD BG 52 (52 wt.-% in butyl glycol) | 0.4 | 0.4 | 0.4 |
| | BYK 345 | 0.2 | 0.2 | 0.2 |
| | Viscalex HV30 10% blend in water | 6.1 | 6.1 | 6.1 |
| | DSX ® 1550 (20.5% in 19.5% water and 50% butyl cellosolve and 10% butyl carbitol) | 0.7 | 0.7 | 0.7 |
| | Carbon Black Dispersion PP6 | — | — | 0.1 |
| | 3.5 wt. % Laponite RD + 3.5 wt. % Pluricol P1010 in H₂O (thickener) | 9.5 | 9.5 | 9.4 |
| | Resimene ® HM 2608 (melamine crosslinker) | 6.1 | 6.1 | 6.1 |
| | Glycol Ether TPM | 1.0 | 1.0 | 1.0 |
| | Shellsol ™ OMS | 0.8 | 0.8 | 0.8 |
| | 2-Ethylhexanol | 1.0 | 1.0 | 1.0 |
| | N,N-dimethylethanolamine | 0.1 | 0.1 | 0.1 |
| Organic Phase | Xirallic NXT M260-30 SW Leonis Gold from Merck KGaA | 1.0 | — | — |
| | Iriodin 9221 SW from Merck KGaA | — | 3.9 | — |
| | Colorstream ® T20-04 WNT Lapis Sunlight from Merck KGaA | 0.9 | — | — |
| | Exterior Mearlin CFS Fine Violet 5303V from Sun Chemical | — | — | 3.5 |
| | Exterior Mearlin CFS Fine Blue 6303V from Sun Chemical | — | — | 0.7 |
| | Butyl glycol | 10.1 | 8.6 | 8.2 |
| | Polyester resin A⁷ | 2.5 | 2.5 | 2.5 |
| | N,N-dimethylethanolamine (20 wt.-% in water) | 0.3 | 0.3 | 0.3 |

| | | | |
|---|---|---|---|
| Sum | 100.0 | 100.0 | 100.0 |

⁵PU Dispersion A (see Table 2);
⁶PU Dispersion B (see Table 2);
⁷Polyester resin A (see Table 2)

TABLE 4
Non-inventive Second Basecoat Composition E

| Midcoat Composition E | Ingredients | Amounts by weight |
|---|---|---|
| | Daotan ® VTW 6462/36WA | 5.6 |
| | PU dispersion B⁶ (35.5 wt. % PU, 8.8 wt. % butyl glycol, 55.7 wt. % H₂O) | 5.6 |
| | PU dispersion A⁵ (27 wt. % PU solids, 4 wt. % ketone, 4 wt. % Pluricol P1010, | 26.8 |
| | 65 wt. % H₂O) | |
| | BYK 345 | 0.2 |
| | Phthalocyanine Blue Dispersion PP9 | 0.6 |
| | Carbazole Blue Dispersion PP8 | 0.3 |
| | 3.5 wt. % Laponite RD + 3.5 wt. % Pluricol P1010 in H₂O (thickener) | 10.3 |
| | Resimene ® HM 2608 (melamine crosslinker) | 6.7 |
| | TMDD BG 52 (52 wt.-% in butyl glycol) | 0.4 |
| | BYK 345 | 0.2 |
| | N-methyl pyrrolodinone | 2.2 |
| | Shellsol ™ OMS | 1.1 |
| | 2-Ethylhexanol | 1.1 |
| | Butyl glycol | 2.6 |
| | Polyester resin A⁷ | 1.4 |
| | Viscalex HV30 10% blend in water | 8.3 |
| | Butyl glycol | 2.6 |
| | Polyester resin A⁷ | 1.4 |
| | N,N-dimethylethanolamine | 0.2 |
| | water | 21.5 |
| | DSX ® 1550 (20.5% in 19.5% water and 50% butyl cellosolve and 10% butyl | 0.7 |
| | carbitol) | |
| | N,N-dimethylethanolamine (20 wt.-% in water) | 0.2 |
| | Sum | 100.0 |

⁵PU Dispersion A (see Table 2);
⁶PU Dispersion B (see Table 2);
⁷Polyester resin A (see Table 2)

### Results

### Three-Layer Coatings ([L1(A)]-[L2(D) or E]-[Clearcoat]) and Two-Layer Coatings ([F]-[Clearcoat])

In Tables 5-1 and 5-2, three multilayer coatings are compared, the first one being inventive and making use of a first basecoat compositions A to form a first basecoat layer L1(A) followed by making use of an inventive second basecoat composition D containing a brush block copolymer to form a second basecoat layer L2(D) followed by making use of a clear coat composition to form layer L3. The second non-inventive multilayer coating makes use of a first basecoat compositions A to form a first basecoat layer L1(A) followed by making use of a non-inventive second basecoat composition E tinted with a non-platelet organic pigment paste to form a second basecoat layer followed by making use of a clear coat composition to form a top coat layer. The third 1s multilayer coating makes only use of one basecoat composition F to form one basecoat layer, followed by making use of a clear coat composition to form a top coat layer. The data in Tables 5-1 and 5-2 show the innovative color space of the inventive multilayer composition compared to the non-inventive compositions.

TABLE 5-1

| | Off-Specular | | | | | |
|---|---|---|---|---|---|---|
| Layers | (°) | L* | a* | b* | C* | h |
| L1(A) + | −15 | 71.68 | −24.84 | −11.83 | 27.51 | 205.46 |
| L2(D) + | +15 | 73.78 | −21.30 | 8.40 | 22.89 | 158.47 |
| L3 | +25 | 54.24 | −14.41 | −1.62 | 14.50 | 186.40 |
| | +45 | 32.47 | −18.51 | −16.22 | 24.61 | 221.23 |
| | +75 | 32.19 | −39.04 | −7.29 | 39.72 | 190.58 |
| | +110 | 31.18 | −41.66 | −4.07 | 41.85 | 185.58 |
| L1(A) + | −15 | 61.06 | −29.14 | −28.55 | 40.80 | 224.41 |
| E + L3 | +15 | 63.77 | −30.53 | −4.79 | 30.91 | 188.91 |
| | +25 | 50.93 | −22.94 | 1.14 | 22.97 | 177.17 |
| | +45 | 27.20 | −10.32 | 2.95 | 10.73 | 164.05 |
| | +75 | 11.63 | −1.97 | 0.29 | 1.99 | 171.50 |
| | +110 | 5.99 | 0.01 | −1.40 | 1.40 | 270.53 |
| F + L3 | −15 | 46.44 | −23.92 | −9.93 | 25.90 | 202.56 |
| | +15 | 45.50 | −22.15 | −7.20 | 23.29 | 198.01 |
| | +25 | 40.76 | −20.33 | −10.62 | 22.93 | 207.59 |
| | +45 | 35.18 | −18.23 | −15.67 | 24.04 | 220.67 |
| | +75 | 34.43 | −17.56 | −18.46 | 25.48 | 226.43 |
| | +110 | 33.24 | −17.88 | −19.26 | 26.28 | 227.12 |

In the near off-specular range (−15° to +15° angle) there is a pronounced difference in the color position of the inventive multilayer coating that is not able to be attained with conventional traditional pigments, regardless of layering with a tinted basecoat composition or composition F.

TABLE 5-2

| | Off-Specular | | | | | |
|---|---|---|---|---|---|---|
| Differences | (°) | ΔL* | Δa* | Δb* | ΔC* | Δh |
| Δ | −15 | 10.62 | 4.30 | 16.73 | −13.29 | −11.03 |
| [(L1(A) + | +15 | 10.00 | 9.24 | 13.19 | −8.01 | −13.97 |
| L2(D) + | +25 | 3.31 | 8.53 | −2.75 | −8.47 | 2.94 |
| L3] − | +45 | 5.27 | −8.19 | −19.17 | 13.88 | 15.55 |
| [L1(A) + | +75 | 20.56 | −37.07 | −7.59 | 37.73 | 2.95 |
| E + L3] | +110 | 25.19 | −41.67 | −2.67 | 40.46 | −10.34 |
| Δ | −15 | 25.24 | −0.92 | −1.89 | 1.61 | 1.35 |
| [L1(A) + | +15 | 28.28 | 0.85 | 15.6 | −0.40 | −15.62 |
| L2(D) + | +25 | 13.48 | 5.92 | 9.00 | −8.44 | −6.70 |
| L3] − | +45 | −2.71 | −0.28 | −0.55 | 0.57 | 0.24 |
| [F + L3] | +75 | −2.24 | −21.48 | 11.17 | 14.24 | −19.58 |
| | +110 | −2.06 | −23.77 | 15.19 | 15.57 | −23.52 |

### Three-Laver Coatings ([L1(B)]-[L2(D) or E]-[Clearcoat]) and Two-Layer Coatings ([G]-[Clearcoat])

In Tables 6-1 and 6-2, three multilayer coatings are compared, the first one being inventive and making use of a first basecoat compositions B to form a first basecoat layer L1(B) followed by making use of an inventive second basecoat composition D containing a brush block copolymer to form a second basecoat layer L2(D) followed by making use of a clear coat composition to form layer L3. The second non-inventive multilayer coating makes use of a first basecoat compositions B to form a first basecoat layer L1(B) followed by making use of a non-inventive second basecoat composition E tinted with a non-platelet organic pigment paste to form a second basecoat layer followed by making use of a clear coat composition to form a top coat layer. The third multilayer coating makes only use of one basecoat composition G to form one basecoat layer, followed by making use of a clear coat composition to form a top coat layer. The data in Tables 6-1 and 6-2 show the innovative color space of the inventive multilayer composition compared to the non-inventive compositions.

TABLE 6-1

| | Off-Specular | | | | | |
|---|---|---|---|---|---|---|
| Layers | (°) | L* | a* | b* | C* | h |
| L1(B) + | −15 | 52.97 | −33.11 | −37.85 | 50.29 | 228.83 |
| L2(D) + | +15 | 52.52 | −35.16 | −36.06 | 50.36 | 225.72 |
| Clearcoat | +25 | 45.82 | −30.50 | −34.87 | 46.32 | 228.83 |
| | +45 | 34.85 | −27.09 | −29.59 | 40.12 | 227.52 |
| | +75 | 35.33 | −42.19 | −16.17 | 45.18 | 200.97 |
| | +110 | 34.53 | −45.16 | −12.40 | 46.83 | 195.35 |
| L1(B) + | −15 | 30.45 | −20.16 | −32.99 | 38.66 | 238.58 |
| E + L3 | +15 | 30.74 | −20.73 | −32.31 | 38.39 | 237.32 |
| | +25 | 28.51 | −19.35 | −30.44 | 36.07 | 237.55 |
| | +45 | 22.36 | −15.20 | −25.81 | 29.96 | 239.50 |
| | +75 | 13.78 | −7.75 | −19.41 | 20.90 | 248.22 |
| | +110 | 7.40 | −2.16 | −14.35 | 14.51 | 261.43 |
| G + L3 | −15 | 40.46 | −17.20 | −32.53 | 36.80 | 242.14 |
| | +15 | 40.84 | −20.21 | −32.03 | 37.87 | 237.74 |
| | +25 | 35.96 | −22.14 | −26.07 | 34.20 | 229.66 |
| | +45 | 29.09 | −24.24 | −16.66 | 29.42 | 214.50 |
| | +75 | 26.49 | −24.90 | −11.61 | 27.48 | 205.00 |
| | +110 | 24.78 | −25.39 | −9.60 | 27.14 | 200.72 |

In the near off-specular range (−15° to +15° angle) there is a pronounced difference in the color position of the inventive multilayer coating that is not able to be attained with conventional traditional pigments, regardless of layering with a tinted basecoat composition or composition G.

TABLE 6-2

| | Off-Specular | | | | | |
|---|---|---|---|---|---|---|
| Differences | (°) | ΔL* | Δa* | Δb* | ΔC* | Δh |
| Δ [(L1(B) + | −15 | 22.52 | −12.95 | −4.86 | 11.63 | −9.75 |
| L2(D) + L3] − | +15 | 21.78 | −14.43 | −3.75 | 11.97 | −11.60 |
| [L1(B) + | +25 | 17.32 | −11.15 | −4.43 | 10.26 | −8.72 |
| E + L3] | +45 | 12.49 | −11.89 | −3.77 | 10.16 | −11.98 |
| | +75 | 21.54 | −34.44 | 3.24 | 24.28 | −47.25 |
| | +110 | 27.13 | −43.00 | 1.95 | 32.32 | −66.08 |
| Δ [L1(B) + | −15 | 12.51 | −15.91 | −5.32 | 13.49 | −13.31 |
| L2(D) + L3] − | +15 | 11.68 | −14.94 | −4.03 | 12.49 | −12.02 |
| [F + L3] | +25 | 9.86 | −8.36 | −8.80 | 12.13 | −0.83 |
| | +45 | 5.76 | −2.85 | −12.93 | 10.70 | 13.02 |
| | +75 | 8.83 | −17.29 | −4.56 | 17.70 | −4.03 |
| | +110 | 9.75 | −19.78 | −2.80 | 19.69 | −5.37 |

### Three-Laver Coatings ([L1(C)]-[L2(D) or E]-[Clearcoat]) and Two-Layer Coatings ([H1]-[Clearcoat])

In Tables 7-1 and 7-2, three multilayer coatings are compared, the first one being inventive and making use of a first basecoat compositions C to form a first basecoat layer L1(C) followed by making use of an inventive second basecoat composition D containing a brush block copolymer to form a second basecoat layer L2(D) followed by making use of a clear coat composition to form layer L3. The second non-inventive multilayer coating makes use of a first basecoat compositions B to form a first basecoat layer L1(C) followed by making use of a non-inventive second basecoat composition E tinted with a non-platelet organic pigment paste to form a second basecoat layer followed by making use of a clear coat composition to form a top coat layer. The third multilayer coating makes only use of one basecoat composition H to form one basecoat layer, followed by making use of a clear coat composition to form a top coat layer. The is data in Tables 7-1 and 7-2 show the innovative color space of the inventive multilayer composition compared to the non-inventive compositions.

TABLE 7-1

| | Off-Specular | | | | | |
|---|---|---|---|---|---|---|
| Layers | (°) | L* | a* | b* | C* | h |
| L1(C) + | −15 | 33.96 | 17.75 | −46.29 | 49.57 | 290.98 |
| L2(D) + | +15 | 34.10 | 5.38 | −41.60 | 41.95 | 277.36 |
| L3 | +25 | 27.51 | 1.38 | −34.87 | 34.90 | 272.27 |
| | +45 | 20.01 | −7.78 | −24.19 | 25.41 | 252.18 |
| | +75 | 20.95 | −22.15 | −11.66 | 25.03 | 207.78 |
| | +110 | 20.31 | −24.64 | −7.19 | 25.67 | 196.26 |
| L1(C) + | −15 | 20.84 | 13.26 | −37.43 | 39.71 | 289.50 |
| E + L3 | +15 | 21.82 | 7.76 | −36.23 | 37.05 | 282.08 |
| | +25 | 18.43 | 5.08 | −31.00 | 31.41 | 279.30 |
| | +45 | 11.54 | 2.37 | −20.90 | 21.03 | 276.46 |
| | +75 | 6.70 | 1.41 | −11.25 | 11.33 | 277.17 |
| | +110 | 4.64 | 1.30 | −6.15 | 6.28 | 281.94 |
| H + L3 | −15 | 31.4 | 3.51 | −30.97 | 31.17 | 276.46 |
| | +15 | 30.17 | 1.48 | −32.49 | 32.53 | 272.61 |
| | +25 | 26.66 | −2.84 | −28.61 | 28.75 | 264.34 |
| | +45 | 22.30 | −9.12 | −21.28 | 23.16 | 246.80 |
| | +75 | 21.32 | −11.67 | −17.54 | 21.07 | 236.37 |
| | +110 | 20.12 | −12.73 | −15.89 | 20.36 | 231.31 |

In the near off-specular range (−15° to +15° angle) there is a pronounced difference in the color position of the inventive multilayer coating that is not able to be attained with conventional traditional pigments, regardless of layering with a tinted basecoat composition or composition H.

TABLE 7-2

| | Off-Specular | | | | | |
|---|---|---|---|---|---|---|
| Differences | (°) | ΔL* | Δa* | Δb* | ΔC* | Δh |
| Δ [(L1(C) + | −15 | 13.12 | 4.49 | −8.86 | 9.86 | 1.48 |
| L2(D) + L3] − | +15 | 12.28 | −2.38 | −5.37 | 4.90 | −4.72 |
| [L1(C) + | +25 | 9.08 | −3.69 | −3.87 | 3.48 | −7.03 |
| E + L3] | +45 | 8.47 | −10.14 | −3.29 | 4.38 | −24.28 |
| | +75 | 14.25 | −23.56 | −0.42 | 13.70 | −69.39 |
| | +110 | 15.67 | −25.94 | −1.04 | 19.39 | −85.68 |
| Δ [L1(C) + | −15 | 2.56 | 14.24 | −15.32 | 18.40 | 14.52 |
| L2(D) + L3] − | +15 | 3.94 | 3.89 | −9.11 | 9.42 | 4.75 |
| [H + L3] | +25 | 0.84 | 4.22 | −6.27 | 6.15 | 7.93 |
| | +45 | −2.29 | 1.35 | −2.90 | 2.25 | 5.38 |
| | +75 | −0.37 | −10.48 | 5.88 | 3.96 | −28.59 |
| | +110 | 0.19 | −11.91 | 8.71 | 5.31 | −35.05 |

1. A multilayer coating system present on an optionally pre-coated substrate and comprising at least three coatings layers L1, L2 and L3 being different from one another:
a first coating layer L1 comprising at least one kind of a platelet-shaped pigment applied over at least a portion of an optionally pre-coated substrate,
a second coating layer L2 applied over the first coating layer L1, and
a third coating layer L3 applied over the second coating layer L2,
characterized in that the second coating layer L2 is formed from a coating composition comprising at least one block copolymer containing a backbone and at least two blocks B1 and B2 different from one another,
wherein block B1 comprises at least one kind of side chains S1 attached to the backbone and block B2 comprises at least one kind of side chains S2 attached to the backbone, which are different from side chains S1, wherein each of side chains S1 comprises at least one polymeric moiety M1 selected from the group consisting of polyester, polyether and poly(meth)acrylate moieties, and each of side chains S2 comprises at least one polymeric moiety M2 different from polymeric moiety M1 and selected from the group consisting of polyester, poly(meth)acrylate, polyether, polysiloxane and polystyrene moieties.

2. The multilayer coating system according to claim 1, wherein the at least one kind of platelet-shaped pigment is selected from the group consisting of metal effect pigments and special effect pigments.

3. The multilayer coating system according to claim 2, wherein the metal effect pigments are selected from the group consisting of coated and uncoated metals and alloys; wherein the special effect pigments are selected from the group consisting of pearlescent pigments and interference pigments.

4. The multilayer coating system according to claim 2, wherein:
the metal effect pigments are surface-modified or not surface-modified and are selected from the group consisting of aluminum platelets, zinc-copper platelets, copper platelets, nickel platelets, and steel platelets; and
the special effect pigments are selected from the group consisting of:
platelets selected from the group consisting of mica, silica, alumina, glass and borosilicate, which are coated with one or more of rutile, anatase, ZrO₂, SnO₂, SiO₂, FeOOH, Fe₂O₃, Cr₂O₃, TiO₂₋ₓ, TiOₓN_{y}, KFe[Fe(CN)₆] and colorant coatings; and
platelets selected from the group consisting of substrate-free pearlescent pigments, natural pearl essence, basic lead carbonate, bismuth oxychloride, micaceous iron oxide and titanium dioxide flakes.

5. The multilayer coating system according to claim 1, wherein the platelet-shaped pigments possess a numerical average platelet thickness h₅₀ in a range from 30 nm to 1 μm, a median platelet diameter D₅₀ in a range from 5 μm to 40 μm, and an average aspect ratio D₅₀/h₅₀ in a range from about 5:1 to about 1300:1, wherein D₅₀ is the volume-based median particle size as determined by laser diffraction spectrometry and h₅₀ is the average particle thickness as determined by electron microscopy.

6. The multilayer coating system according to claim 1, wherein it further contains a non-platelet-shaped, visible light absorbing pigment.

7. The multilayer coating system according to claim 1, wherein the at least one kind of platelet-shaped pigment contained in the first coating layer L1 is capable of reflecting at least those wavelengths that are not reflected by the second layer L2.

8. The multilayer coating system according to claim 1, wherein the third coating layer L3 is formed from a coating composition, which is a clearcoat composition.

9. The multilayer coating system according to claim 1, wherein at least the first, second and the third coating layers L1, L2 and L3 are positioned adjacently to each other, and in that coating layers L2 and L3 are at least partially transparent for visible light.

10. The multilayer coating system according to claim 1, wherein it is obtained by a method, according to which at least the applied coating composition comprising the at least one block copolymer, which is used for preparing the second coating layer L2, and the applied coating composition used for preparing the third coating layer L3 are jointly cured to obtain the second and third coating layers L2 and L3 of the multilayer coating system.

11. The multilayer coating system according to claim 1, wherein the backbone of the copolymer comprises ethylenically unsaturated carbon-carbon double bonds.

12. The multilayer coating system according to claim 1, wherein each of side chains S1 of the first block B1 of the copolymer comprises at least one polymeric moiety M1, and
each of side chains S2 of the second block B2 of the copolymer comprises at least one polymeric moiety M2, which is free from both hydroxyl and carboxylic acid groups.

13. The multilayer coating system according to claim 1, wherein the at least one copolymer has a number average molecular weight (Mₙ) in a range of from 450 to 6000 kDa.

14. The multilayer coating system according to claim 1, wherein
the first block B1 of the copolymer comprises at least one structural unit SU1a and optionally at least one structural unit SU1b, wherein structural unit SU1a is represented by at least one of part structures PS1a-1 and PS1a-2, and wherein optionally present structural unit SU1b is represented by part structure PS1b, 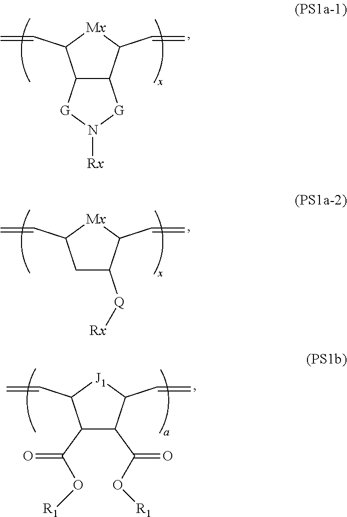
wherein independently of one another:
parameter x is in a range of from 1 to 1000,
parameter a is in a range of from 0 to 1000,
the relative ratio of parameters x:a is in a range of from 1:0 to 1:3,
Mx, J₁ and G represent independently of one another CH₂ or C═O,
Q represents a divalent alkyl, heteroalkyl, cycloalkyl, heterocycloalkyl, aryl or heteroaryl residue,
Rx represents side chain S1 comprising polymeric moiety M1, wherein parameter n is in a range of from 1 to 500, and
R₁ represents a C₁-C₆-alkyl residue, wherein the second block B2 of the copolymer comprises at least one structural unit SU2a and optionally at least one structural unit SU2b, wherein structural unit SU2a is represented by at least one of part structures PS2a-1 and PS2a-2, and wherein optionally present structural unit SU2b is represented by part structure PS2b, 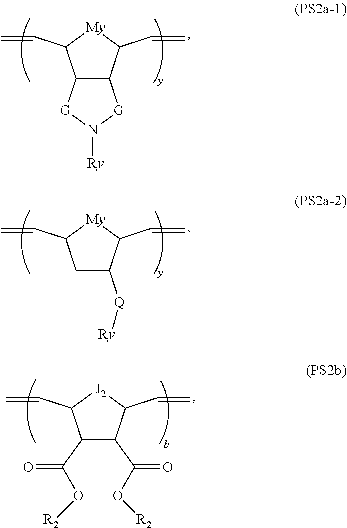
wherein independently of one another:
parameter y is in a range of from 1 to 1000,
parameter b is in a range of from 0 to 1000,
the relative ratio of parameters y:b is in a range of from 1:0 to 1:3,
My, J₂ and G represent independently of one another CH₂ or C═O,
Q represents a divalent alkyl, heteroalkyl, cycloalkyl, heterocycloalkyl, aryl or heteroaryl residue,
Ry represents side chain S2 comprising polymeric moiety M2, and T represents a C₁-C₄-alkylene residue, to which a polystyrene moiety is bonded, and
R₂ represents a C₁-C₆-alkyl residue.

15. The multilayer coating system according to claim 1, wherein the at least one copolymer is present in the coating composition used for preparing the second coating layer L2, in an amount in the range of from 10 to 100 wt.-%, based on the total solid content of the coating composition.

16. The multilayer coating system according to claim 1, wherein the coating composition comprising the at least one block copolymer used for preparing the second coating layer L2 further comprises at least one homopolymer.

17. The multilayer coating system according to claim 1, wherein the coating composition comprising the at least one block copolymer used for preparing the second coating layer L2 comprises at least one further resin.

18. A method for preparing the multilayer coating system according to claim 1, comprising at least steps (1), (2), (3) and (4),
(1) applying a pigmented basecoat composition to at least a portion of an optionally pre-coated substrate and forming a first coating film on at least a portion of the optionally pre-coated substrate,
(2) applying a second basecoat composition comprising the at least one block copolymer and being different from the basecoat composition applied in step (1) to the first coating film present on the substrate obtained after step (1) and forming a second coating film,
(3) applying a coating composition different from the compositions applied in steps (1) and (2) to the second coating film present on the substrate obtained after step (2) and forming a third coating film, and
(4) jointly curing at least the second and third coating films applied in steps (2) and (3) and optionally also the first coating film applied in step (1) in case said first coating film was not cured prior to performing of step (2) to obtain a multilayer coating system comprising at least the first, the second and the third coating layers L1, L2 and L3.

19. A coated substrate obtainable by the method according to claim 18.

20. The multilayer coating system according to claim 10, wherein curing is selected from the group consisting of chemical curing, chemical crosslinking, radiation curing, and/or physically drying (non-chemical curing), in each case at room temperature or at an elevated temperature, wherein the minimum curing temperature applied for curing is 80° C.
